(19) United States
(12) Patent Application Publication
(10) Pub. No.: US 2024/0003235 A1
(43) Pub. Date: Jan. 4, 2024

(54) FRACTURING OPERATION SYSTEM

(71) Applicant: Schlumberger Technology Corporation, Sugar Land, TX (US)

(72) Inventors: Jared Michael Bruns, Sugar Land, TX (US); Andrey Konchenko, Menlo Park, CA (US); Andrew Bonnell, Sugar Land, TX (US); Juan David Estrada Benavides, Katy, TX (US)

(21) Appl. No.: 18/250,565

(22) PCT Filed: Oct. 29, 2021
(86) PCT No.: PCT/US2021/057179

§ 371 Date: Apr. 26, 2023

Related U.S. Application Data
(60) Provisional application No. 63/107,955, filed on Oct. 30, 2020.

(51) Int. Cl. E21B 43/26; G05B 13/02; E21B 47/00

(52) U.S. Cl. CPC E21B 43/26; G05B 13/0265; E21B 47/00; E21B 2200/20; E21B 2200/22

(57) ABSTRACT

A method can include, for a control action for a hydraulic fracturing operation of a well, using a trained machine learning model that predicts treatment pressure of the hydraulic fracturing operation, determining if the control action increases efficiency; if the control action increases efficiency, assessing viability of the control action with respect to one or more predefined criteria; and, if the control action is viable, issuing the control action for implementation during the hydraulic fracturing operation.

### RELATED APPLICATIONS

This application claims priority to and the benefit of a U.S. Provisional Application having Ser. No. 63/107,955, filed 30 Oct. 2020, which is incorporated by reference herein.

### BACKGROUND

A field operation can include fracturing of a formation, which can be, for example, a reservoir. As an example, a fracturing operation may be referred to as a fracturing job. Hydraulic fracturing (e.g., a stimulation treatment) may be performed on oil and gas wells in low-permeability reservoirs. For example, engineered fluids (e.g., including chemicals such as surfactants, polymers, polymeric surfactants, etc.) can be pumped at high pressure and rate into a reservoir interval to be treated where fracture generation and/or reopening occurs. As an example, wings of a fracture can extend away from a wellbore in opposing directions, for example, according to the natural stresses within the formation. An operation can utilize proppant, such as grains of sand of a particular size, mixed with treatment fluid to keep the fracture open when the treatment is complete. Hydraulic fracturing can aim to create high-conductivity communication with a large area of formation.

### SUMMARY

A method can include, for a control action for a hydraulic fracturing operation of a well, using a trained machine learning model that predicts treatment pressure of the hydraulic fracturing operation, determining if the control action increases efficiency; if the control action increases efficiency, assessing viability of the control action with respect to one or more predefined criteria; and, if the control action is viable, issuing the control action for implementation during the hydraulic fracturing operation. A system can include a processor; memory accessible to the processor; processor-executable instructions stored in the memory and executable to instruct the system to: for a control action for a hydraulic fracturing operation of a well, using a trained machine learning model that predicts treatment pressure of the hydraulic fracturing operation, determine if the control action increases efficiency; if the control action increases efficiency, assess viability of the control action with respect to one or more predefined criteria; and, if the control action is viable, issue the control action for implementation during the hydraulic fracturing operation. One or more computer-readable storage media can include computer-executable instructions executable to instruct a computing system to: for a control action for a hydraulic fracturing operation of a well, using a trained machine learning model that predicts treatment pressure of the hydraulic fracturing operation, determine if the control action increases efficiency; if the control action increases efficiency, assess viability of the control action with respect to one or more predefined criteria; and, if the control action is viable, issue the control action for implementation during the hydraulic fracturing operation. Various other methods, systems, etc. are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a technique;

FIG. 2 illustrates an example of a method;

FIG. 3 illustrates an example of a system;

FIG. 4 illustrates an example of a portion of a method;

FIG. 5 illustrates an example of a portion of the method of FIG. 4;

FIG. 6 illustrates examples of techniques and equipment associated with microseismicity;

FIG. 7 illustrates examples of equipment of a system;

FIG. 8 illustrates examples of equipment of a system;

FIG. 9 illustrates an example of a system and examples of graphical user interfaces (GUIs);

FIG. 10 illustrates an example of a schema;

FIG. 11 illustrates an example of a graphical user interface (GUI);

FIG. 12 illustrates an example of a graphical user interface (GUI);

FIG. 13 illustrates an example of a method;

FIG. 14 illustrates an example of a system and examples of graphical user interfaces (GUls);

FIG. 15 illustrates an example of a method and an example of a system; and

FIG. 16 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Various field operations can include controllable equipment. For example, a controller can be operatively coupled to one or more pieces of equipment to control one or more actions thereof. As an example, a controller can provide for control of pumping equipment and, for example, measurement equipment, which can include one or more sensors.

As to pumping fluid, consider, as an example, hydraulic fracturing operations that can include pumping fluid into a borehole in a formation to generate fractures in the formation. Such pumping can utilize a pump driven by an internal combustion engine where a drive shaft of the internal combustion engine can be operatively coupled to a transmission, which can include various gears that can gear-up or gear-down rotational speed of the drive shaft of the internal combustion engine in a manner that aims to effectively control a pump shaft to achieve one or more desirable pumping parameters (e.g., pump pressure, pump flow rate, etc.). While a single pump is mentioned, a field operation can involve a fleet of pumps where each pump may be mounted on a trailer along with an internal combustion engine and a transmission. A fleet operation can pump fluid to a manifold or manifolds, mixing equipment, etc. A fleet can include homogenous equipment or heterogeneous equipment. For example, a fleet can include a plurality of trailers that include equipment with common specifications or with at least some differing specifications. Further, even where equipment has common specifications, there can be differences in history and/or manufactured specifications from unit to unit, system to system, etc. In some instances, each pump system in a fleet may differ and possess its own characteristics, peculiarities, behaviors, etc. Such a fleet can make unified control problematic, which can result in suboptimal pumping, suboptimal hydraulic fracture generation, suboptimal equipment usage, etc. As explained herein, controller optimization via reinforcement learning on a digital avatar can be utilized to generate an optimized controller that can be utilized to control a fleet.

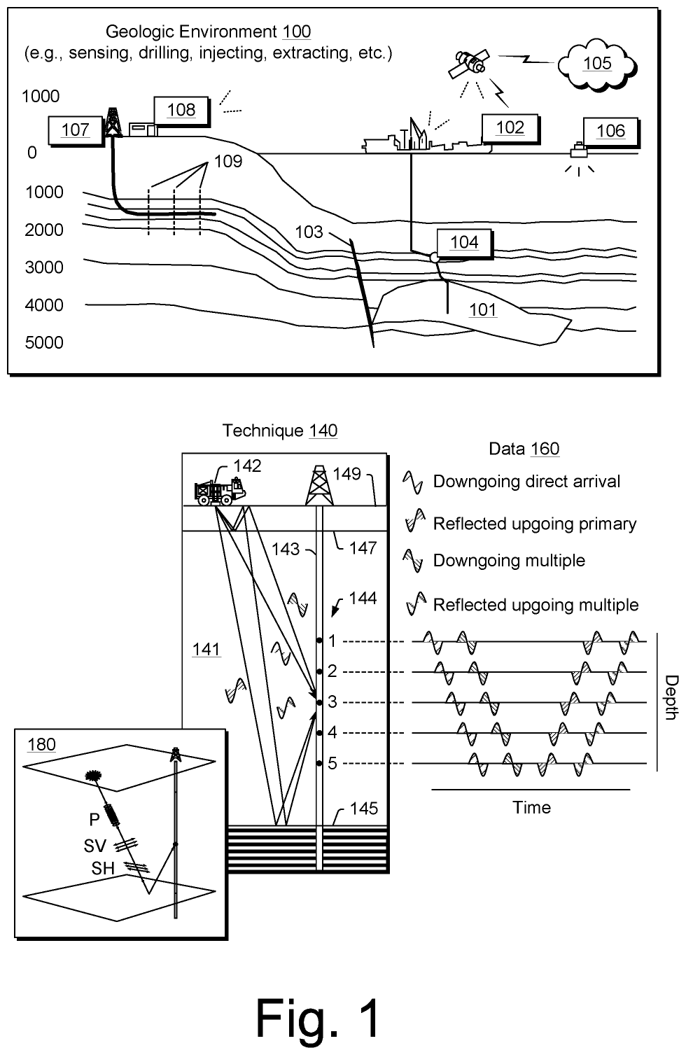

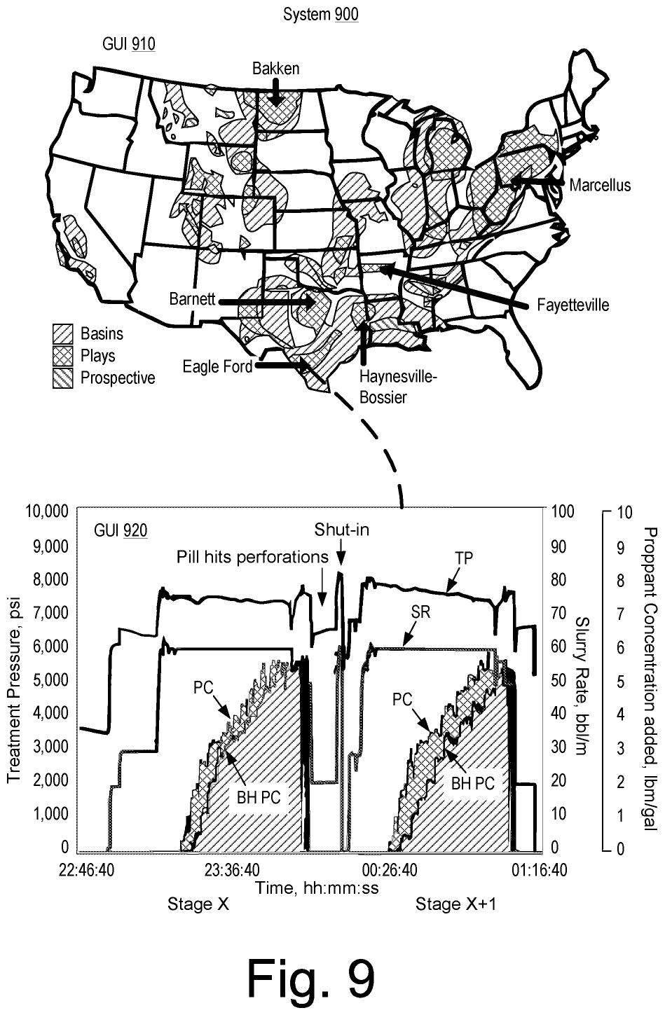

Below, FIGS. 1 to 8 illustrate some examples of operations, equipment, etc., that can be performed, utilized, etc., in hydraulic fracturing. FIGS. 9 to 15 illustrate some examples of operations, methods, systems, workflows, etc., which may be utilized in hydraulic fracturing where, for example, a model-based approach may enhance operational efficiency. For example, one or more of the operations, equipment, etc., of FIGS. 1 to 8 may be utilized in a model-based workflow that enhances operational efficiency and/or provides one or more other benefits (e.g., reduced water utilization, reduced chemical utilization, reduce formation damage/damage risk, etc.).

FIG. 1 shows an example of a geologic environment 100 (e.g., an environment that includes a sedimentary basin, a reservoir 101, a fault 103, one or more fractures 109, etc.) and an example of an acquisition technique 140 to acquire seismic data. As an example, a system may process data acquired by the technique 140, for example, to allow for direct or indirect management of sensing, drilling, injecting, extracting, etc., with respect to the geologic environment 100. In turn, further information about the geologic environment 100 may become available as feedback (e.g., optionally as input to the system). As an example, an operation may pertain to a reservoir that exists in the geologic environment 100 such as, for example, the reservoir 101. As an example, a technique may provide information (e.g., as an output) that may specify one or more location coordinate of a feature in a geologic environment, one or more characteristics of a feature in a geologic environment, etc.

As an example, a system may include a computational environment that can include various features of the DELFI environment, which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, PETREL, TECHLOG, PIPESIM, ECLIPSE, INTERSECT, MANGROVE, and PETROMOD frameworks (Schlumberger Limited, Houston, Texas).

As an example, a system may include features of a simulation framework that provides components that allow for optimization of exploration and development operations (e.g., “E&P” operations). A framework may include seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. As an example, various components may be implemented as add-ons (or plug-ins) that conform to and operate according to specifications of a framework environment (e.g., according to application programming interface (API) specifications, etc.).

The aforementioned DELFI environment is a secure, cognitive, cloud-based collaborative environment that integrates data and workflows with digital technologies, such as artificial intelligence and machine learning. As an example, such an environment can provide for operations that involve one or more computational frameworks. For example, various types of computational frameworks may be utilized within an environment such as a drilling plan framework, a seismic-to-simulation framework, a measurements framework, a mechanical earth modeling (MEM) framework, an exploration risk, resource, and value assessment framework, a reservoir simulation framework, a surface facilities framework, a stimulation framework, etc. As an example, one or more methods may be implemented at least in part via a framework (e.g., a computational framework) and/or an environment (e.g., a computational environment).

In the example of FIG. 1, the geologic environment 100 may include layers (e.g., stratification) that include the reservoir 101 and that may be intersected by a fault 103 (see also, e.g., the one or more fractures 109, which may intersect a reservoir). As an example, a geologic environment may be or include an offshore geologic environment, a seabed geologic environment, an ocean bed geologic environment, etc.

As an example, the geologic environment 100 may be outfitted with any of a variety of sensors, detectors, actuators, etc. For example, equipment 102 may include communication circuitry to receive and to transmit information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 105 that may be configured for communications, noting that the satellite may additionally or alternatively include circuitry for imagery (e.g., spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 107 and/or 108 may include components, a system, systems, etc. for fracturing, seismic sensing, analysis of seismic data, assessment of one or more fractures, etc.

As an example, a system may be used to perform one or more workflows. A workflow may be a process that includes a number of worksteps. A workstep may operate on data, for example, to create new data, to update existing data, etc. As an example, a system may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the DELFI environment. As an example, a workflow may include transmitting information that may control, adjust, initiate, sense, etc. one or more operations of equipment associated with a geologic environment (e.g., in the environment, above the environment, etc.).

In FIG. 1, the technique 140 may be implemented with respect to a geologic environment 141. As shown, an energy source (e.g., a transmitter) 142 may emit energy where the energy travels as waves that interact with the geologic environment 141. As an example, the geologic environment 141 may include a bore 143 where one or more sensors (e.g., receivers) 144 may be positioned in the bore 143. As an example, energy emitted by the energy source 142 may interact with a layer (e.g., a structure, an interface, etc.) 145 in the geologic environment 141 such that a portion of the energy is reflected, which may then be sensed by one or more of the sensors 144. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 141 is shown as including a layer 147 that resides below a surface layer 149. Given such an environment and arrangement of the source 142 and the one or more sensors 144, energy may be sensed as being associated with particular types of waves.

As an example, a “multiple” may refer to multiple reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 1, acquired data 160 can include data associated with downgoing direct arrival waves, reflected upgoing primary waves, downgoing multiple reflected waves and reflected upgoing multiple reflected waves. The acquired data 160 is also shown along a time axis and a depth axis. As indicated, in a manner dependent at least in part on characteristics of media in the geologic environment 141, waves travel at velocities over distances such that relationships may exist between time and space. Thus, time information, as associated with sensed energy, may allow for understanding spatial relations of layers, interfaces, structures, etc. in a geologic environment.

FIG. 1 also shows various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example, seismic data may be acquired for a region in the form of traces. In the example of FIG. 1, the technique 140 may include the source 142 for emitting energy where portions of such energy (e.g., directly and/or reflected) may be received via the one or more sensors 144. As an example, energy received may be discretized by an analog-to-digital converter that operates at a sampling rate. For example, acquisition equipment may convert energy signals sensed by a sensor to digital samples at a rate of one sample per approximately 4 ms. Given a speed of sound in a medium or media, a sample rate may be converted to an approximate distance. For example, the speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

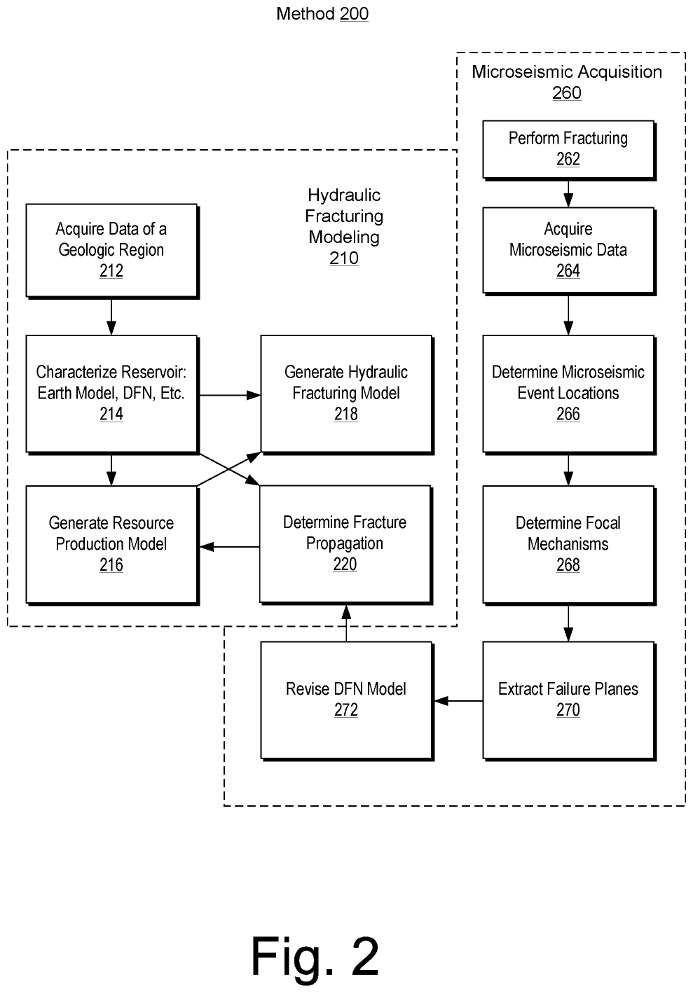

FIG. 2 shows an example of a method 200 that includes various actions associated with hydraulic fracturing modeling 210 and various actions associated with microseismic data acquisition 260. Such a method may be utilized in combination with one or more pieces of equipment, for example, to perform operations, acquire data, etc.

As shown in the example of FIG. 2, the method 200 includes an acquisition block 212 for acquiring data of a geologic region, a characterization block 214 for characterizing a reservoir in the geologic region via a 3D earth model and a discrete fracture network (DFN) and optionally one or more other actions, a generation block 216 for generating a resource production model of the geologic region, a generation block 218 for generating a hydraulic fracturing model and a determination block 220 for determining information associated with fracture propagation in the geologic region. As shown, the method 200 includes a performance block 262 for performing hydraulic fracturing in the geologic region, an acquisition block 264 for acquiring microseismic data responsive to generation and/or reactivation of fractures in the geologic region, a determination block 266 for determining microseismic event locations in the geologic region, a determination block 268 for determining one or more focal mechanisms based at least in part on the microseismic event locations, an extraction block 270 for extracting one or more failure planes based at least in part on the determined one or more focal mechanisms in the geologic region, a revision block 272 for revising the DFN model that characterizes the reservoir where, as shown, the revised DFN model can be utilized to inform the determination block 220 as to fracture propagation in the geologic region noting that one or more loops can exist within the method 200 that can be performed responsive to fracturing and data acquisition, which can inform, for example, one or more operations in the geologic region (e.g., further fracturing, further data acquisition, production, etc.).

Mechanical earth models (e.g., “MEMs”, 3D earth models, etc.) can be generated from a variety of geologic, petrophysical, geomechanical, and geophysical information, which characterizes complexity and heterogeneity of a reservoir and completion properties in one or more formations of interest (see, e.g., the block 214). As an example, data can be acquired via one or more of 3D seismic surveys, acoustic impedance, and other seismic-derived property volumes (e.g., bulk modulus, Poisson's ratio, etc.), microseismic surveys, sonic logs, rock cores, petrophysical measurements from well logs, etc. (see, e.g., the block 212). As an example, natural fracture patterns and regional stress field may be mapped using such multi-domain, multi-scale information as borehole images and 2D and 3D seismic surveys, which can then be used to develop and calibrate fracture propagation models (see, e.g., the block 220). As an example, a mechanical earth model (MEM) may be used to generate maps to assess, perform, etc., one or more of drilling, fracturing, and operational risks. As explained with respect to FIG. 2, the method 200 can include integrating hydraulic fracturing models (see, e.g., the block 218) developed through integration of geologic and structural models with production simulation models and risk maps (see, e.g., the block 216), which can provide for decision making for completion operations, execution of an optimum stimulation plan, etc.

As an example, hydraulic fracturing models developed through the integration of geologic and structural reservoir characterization models, fracture propagation models and production models may be utilized in evaluating different unconventional completion operations. For example, consider operations that include real-time microseismic data acquisition for evaluating performance of hydraulic fracturing stimulations and in providing information about calibrating and developing revised fracture models for one or more of ongoing and future stimulations.

Microseismic monitoring provides a valuable tool to evaluate hydraulic fracture treatments in real-time and can be utilized in planning and managing reservoir development. Microseismic event locations, source characteristics and attributes can provide estimates of hydraulic fracturing geometry that can be evaluated with respect to a completion plan and expected fracture growth. Microseismic event derived attributes such as fracture azimuth, height and length, location, and complexity, may be utilized to determine the extent of fracture coverage of the reservoir target and effective stimulated volume, as well as in diagnosing under-stimulated sections of the reservoir and in planning re-stimulation of under-producing perforations and wells. Microseismic event locations can also help to avoid hazards during stimulation (e.g., faults, karst, aquifers, etc.). As an example, a method can include modifications to one or more treatment plans and operations based at least in part on microseismic interpretations.

As an example, microseismic monitoring results may be used in updating and calibrating geologic and structural models used in planning completions. Information about the inelastic deformation of the fracture source (fracture plane orientation and slip) that generates the microseismic signal may be, for example, obtained through moment tensor inversion. The moment tensor can describe various source types (e.g., explosion, tensile crack opening or closing, slip on a plane or combination thereof). As hydraulic fracture microseismicity can be a result of high-pressure injection of fluids and proppant to open fracture paths, moment tensor inversion can be used to determine fracture opening and closing events from shear displacements, providing valuable information to engineers as to whether their fractures pathways are open or closed. Moment tensors may also provide a direct measurement of the local stress-strain regime, fracture orientations, and changes to the local stresses and fracture orientation through time that can be used to develop and calibrate discrete fracture network (DFN) models.

Integrated workflows leveraging multi-scale, multi-domain measurements and microseismic interpretation can enable optimization of hydraulic fracturing treatment for increased production. Integrated completions planning workflows may use a wide variety of information about the geology (e.g., lithology, stress contrast, natural fracturing, structural or depositional dip, faulting), and the associated rock properties, (e.g., noise, slowness, anisotropy, attenuation) to improve hydraulic fracturing operations to lead to improved hydraulic fracture stimulations, completion plans, and well placement and, thereby, improved production. As an example, microseismic event locations and attributes may be integrated and compared with treatment pressure records, proppant concentration, and injection rate to better perform field operations.

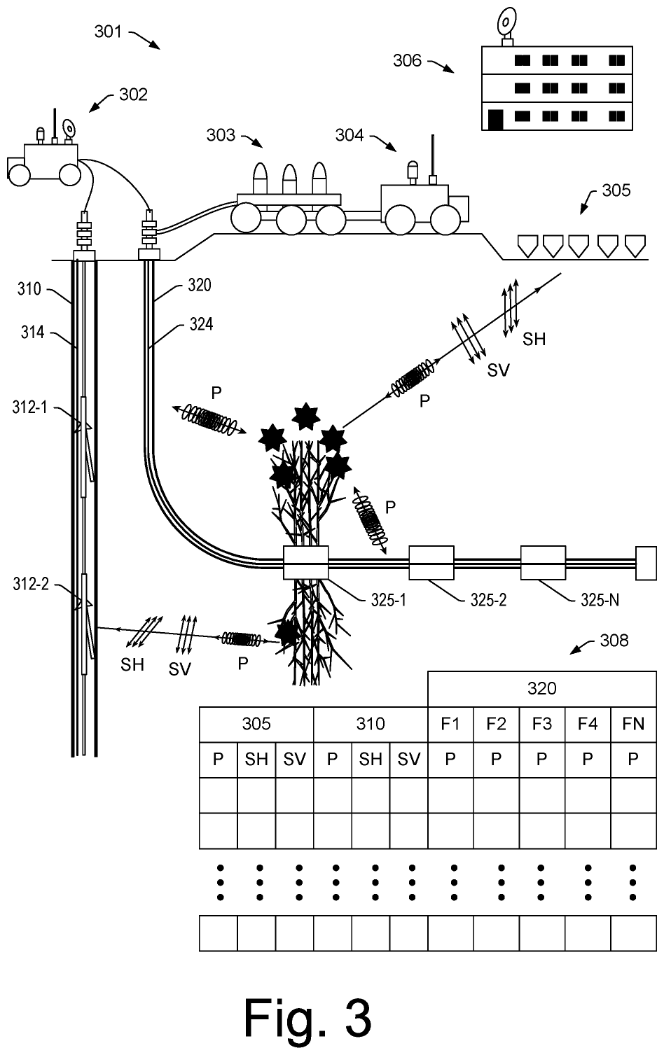

FIG. 3 shows an example of a geologic environment 301 that includes monitoring equipment 302, a pump 303, equipment 304, a seismic sensor or receiver array 305 and a remote facility 306. As shown, various types of communication may be implemented such that one or more pieces of equipment can communicate with one or more other pieces of equipment. As an example, equipment can include geopositioning equipment (e.g., GPS, etc.). As an example, equipment can include one or more satellites and one or more satellite links (e.g., dishes, antennas, etc.).

In the example of FIG. 3, a monitoring well 310 and a treatment well 320 are disposed in the geologic environment 301. The monitoring well 310 includes a plurality of sensors 312-1 and 312-2 and optionally a fiber cable sensor 314 and the treatment well 320 optionally includes a fiber cable sensor 324 and one or more sets of perforations 325-1, 325-2, 325-N (e.g., as generated by perforating equipment, which may utilize force generated via one or more mechanisms).

Equipment in the example of FIG. 3 can be utilized to perform one or more methods. As an example, data associated with hydraulic fracturing events may be acquired via various sensors. As an example, P-wave data (compressional wave data) can be utilized to assess such events (e.g., microseismic events). Such information may allow for adjusting one or more field operations. As an example, data acquired via the fiber cable sensor 324 can be utilized to generate information germane to a fluid flow-based treatment process (e.g., to determine where fluid pumped into a well may be flowing, etc.).

FIG. 3 shows an example of a table or data structure 308 with some examples of information that may be acquired via the seismic sensor array 305 (e.g., P-wave as “P”, SH-wave as “SH”, SV-wave as “SV”), sensors of the monitoring well 810 (e.g., P, SH, SV) and sensors of the treatment well 320 (e.g., P). In the example of FIG. 3, information may be sensed with respect to position, for example, sensor position, position along a fiber cable sensor, etc. As shown, the fiber cable sensor 324 may sense information at a variety of positions along the fiber cable sensor 324 within the treatment well 320 (see, e.g., F1, F2, F3, F4 to FN).

In the example of FIG. 3, the set of perforations 325-1 are shown as including associated fractures and microseismic events that generate energy that can be sensed by various sensors in the geologic environment 301. Arrows indicate a type of wave that may be sensed by an associate sensor. For example, as mentioned with respect to the table or data structure 308, the seismic sensor array 305 can sense P, SV and SH waves while the fiber cable sensor 324 can sense P waves.

As an example, the equipment 302 can be operatively coupled to various sensors in the monitor well 310 and the treatment well 320. As an example, the equipment 302 may be on-site where wires are coupled from sensors to the equipment 302, which may be vehicle-based equipment (e.g., a data acquisition and/or control truck, etc.). As an example, the equipment 304 may control the pump 303 (e.g., or pumps) that can direct fluid into the treatment well 320. For example, a line is shown as a conduit that is operatively coupled between the pump 303 and the treatment well 320.

As an example, information acquired by the equipment 302 may be utilized to control one or more treatment processes controlled by the equipment 304. For example, the equipment 302 and the equipment 304 may be in direct and/or indirect communication via one or more communication links (e.g., wire, wireless, local, remote, etc.). In such an example, information acquired during a treatment process can be utilized in real-time (e.g., near real-time) to control the treatment process. For example, the equipment 302 can acquire data via sensors in the wells 310 and 320 and output information to the equipment 304 for purposes of controlling an on-going treatment process. As an example, such information may be utilized to control and/or to plan a subsequent treatment process, for example, additionally or alternatively to controlling an on-going treatment process.

As an example, a treatment process can include hydraulic fracturing. As an example, acquired data can include microseismic event data. As an example, a method can include determining the extent of rock fracturing induced by a treatment process, which may aim to stimulate a reservoir.

A stimulation (or a stimulation treatment) may be performed to restore or enhance the productivity of a well. Types of stimulations can include hydraulic fracturing treatments and matrix treatments. Fracturing treatments can be performed above a fracture pressure of a reservoir formation and aim to create a conductive flow path between the reservoir and a wellbore. Matrix treatments can be performed below a reservoir fracture pressure and may be designed to restore natural permeability of the reservoir (e.g., following damage to the near-wellbore area, etc.). As an example, stimulation in shale gas reservoirs can involve hydraulic fracturing treatments.

As an example, a method can include hydraulic fracture monitoring (HFM). As an example, a method can include monitoring one or more types of reservoir stimulation processes where one or more of such processes may be performed in stages. As an example, a stage may be of a duration of the order of hours or longer (e.g., several days). As an example, a method can include determining the presence, extent, and/or associated volume of induced fractures and fracture networks, which may be utilized for calculating an estimated reservoir stimulation volume (e.g., ESV) that may assist, for example, in economic evaluation of well performance.

As an example, real-time data may be rendered to a display (e.g., as a plot, plots, etc.). As an example, real-time data may be assessed in real-time (e.g., near real-time that includes computation and transmission times) during perforation flow for one or more sets of perforations. In such an example, such assessments may allow a treatment process to be optimized during the treatment process in real-time (e.g., near real-time). Such assessments may be utilized for one or more post treatment analyses, for example, to plan, perform, control, etc. one or more future treatments (e.g., in a same well, a different well, etc.).

As an example, a method can include acquiring data germane to flow in one or more wells and/or via perforations in one or more wells. As an example, a method can include acquiring data germane to locating one or more fractures. As an example, a method can include a real-time portion and a post-process portion.

As an example, a data acquisition technique may be implemented to help understand a formation, a reservoir, a bore, a bore wall, a fracture, fractures, a fracture network, etc. As an example, a hydraulically induced fracture or fractures may be monitored using one or more borehole seismic methods. For example, while a fracture is being created in a treatment well, a multicomponent receiver array in a monitor well may be used to record microseismic activity generated by a fracturing process.

As mentioned, equipment may include fracturing equipment where such equipment may be employed to generate one or more fractures in a geologic environment. As an example, a method to generate fractures can include a delivery block for delivering fluid to a subterranean environment, a monitor block for monitoring fluid pressure and a generation block for generating fractures via fluid pressure. As an example, the generation block may include activating one or more fractures. As an example, the generation block may include generating and activating fractures.

As an example, a method may be referred to as a treatment method or a “treatment”. Such a method may include pumping an engineered fluid (e.g., a treatment fluid) at high pressure and rate into a reservoir via one or more bores, for example, to one or more intervals to be treated, which may cause a fracture or fractures to open (e.g., new, pre-existing, etc.).

As an example, a fracture may be defined as including “wings” that extend outwardly from a bore. Such wings may extend away from a bore in opposing directions, for example, according in part to natural stresses within a formation. As an example, proppant may be mixed with a treatment fluid to keep a fracture (or fractures) open when a treatment is complete. Hydraulic fracturing may create high-conductivity communication with an area of a formation and, for example, may bypass damage that may exist in a near-wellbore area. As an example, stimulation treatment may occur in stages. For example, after completing a first stage, data may be acquired and analyzed for planning and/or performance of a subsequent stage.

Size and orientation of a fracture, and the magnitude of the pressure to create it, may be dictated at least in part by a formations in situ stress field. As an example, a stress field may be defined by three principal compressive stresses, which are oriented perpendicular to each other. The magnitudes and orientations of these three principal stresses may be determined by the tectonic regime in the region and by depth, pore pressure and rock properties, which determine how stress is transmitted and distributed among formations.

Where fluid pressure is monitored, a sudden drop in pressure can indicate fracture initiation of a stimulation treatment, as fluid flows into the fractured formation. As an example, to break rock in a target interval, fracture initiation pressure exceeds a sum of the minimum principal stress plus the tensile strength of the rock. To determine fracture closure pressure, a process may allow pressure to subside until it indicates that a fracture has closed. A fracture reopening pressure may be determined by pressurizing a zone until a leveling of pressure indicates the fracture has reopened. The closure and reopening pressures tend to be controlled by the minimum principal compressive stress (e.g., where induced downhole pressures exceed minimum principal stress to extend fracture length).

After performing fracture initiation, a zone may be pressurized for furthering stimulation treatment. As an example, a zone may be pressurized to a fracture propagation pressure, which is greater than a fracture closure pressure. The difference may be referred to as the net pressure, which represents a sum of frictional pressure drop and fracture-tip resistance to propagation (e.g., further propagation).

As an example, a method may include seismic monitoring during a treatment operation (e.g., to monitor fracture initiation, growth, etc.). For example, as fracturing fluid forces rock to crack and fractures to grow, small fragments of rock break, causing tiny seismic emissions, called microseisms. Equipment may be positioned in a field, in a bore, etc. to sense such emissions and to process acquired data, for example, to locate microseisms in the subsurface (e.g., to locate hypocenters). Information as to direction of fracture growth may allow for actions that can “steer” a fracture into a desired zone(s) or, for example, to halt a treatment before a fracture grows out of an intended zone. Seismic information (e.g., information associated with microseisms) may be used to plan one or more stages of fracturing operations (e.g., location, pressure, etc.).

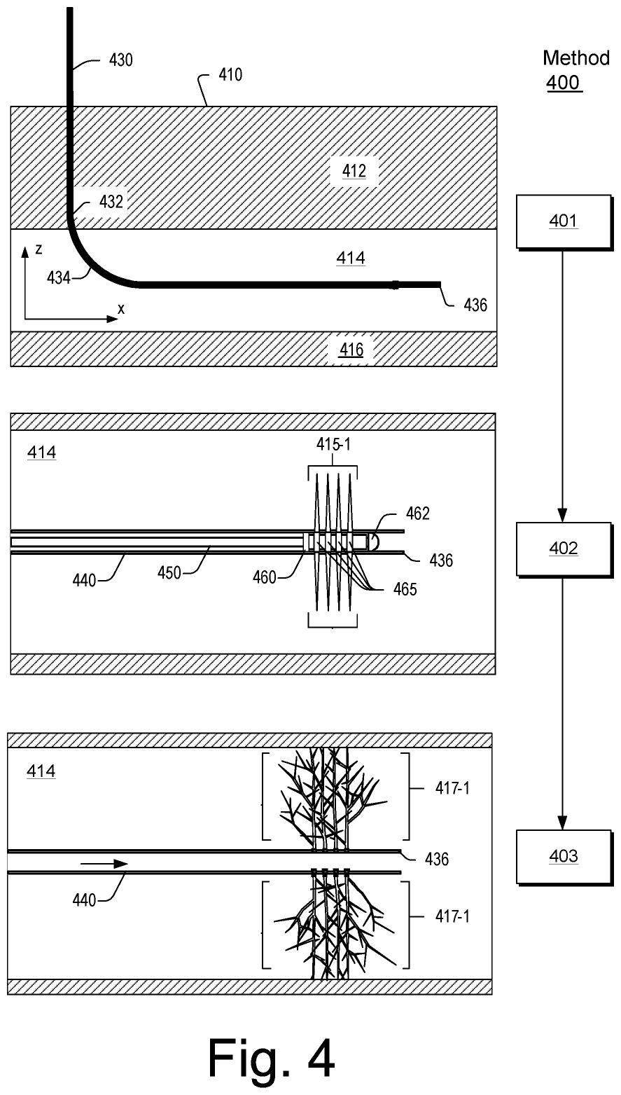

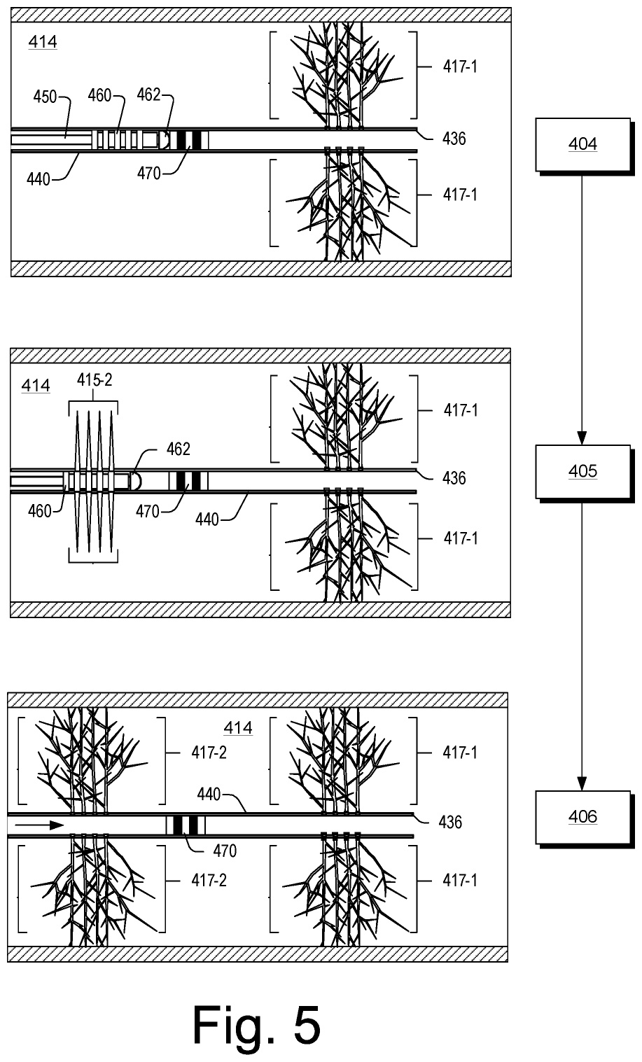

FIGS. 4 and 5 show an example of a method 400 that includes generating fractures. As shown, the method 400 can include various operational blocks such as one or more of the blocks 401, 402, 403, 404, 405 and 406. The block 401 may be a drilling block that includes drilling into a formation 410 that includes layers 412, 414 and 416 to form a bore 430 with a kickoff 432 to a portion defined by a heel 434 and a toe 436, for example, within the layer 414.

As illustrated with respect to the block 402, the bore 430 may be at least partially cased with casing 440 into which a string or line 450 may be introduced that carries a perforator 460. As shown, the perforator 460 can include a distal end 462 and charge positions 465 associated with activatable charges that can perforate the casing 440 and form channels 415-1 in the layer 414. Next, per the block 403, fluid may be introduced into the bore 430 between the heel 434 and the toe 436 where the fluid passes through the perforations in the casing 440 and into the channels 415-1. Where such fluid is under pressure, the pressure may be sufficient to fracture the layer 414, for example, to form fractures 417-1. In the block 403, the fractures 417-1 may be first stage fractures, for example, of a multistage fracturing operation.

Per the block 404, additional operations are performed for further fracturing of the layer 414. For example, a plug 470 may be introduced into the bore 430 between the heel 434 and the toe 436 and positioned, for example, in a region between first stage perforations of the casing 440 and the heel 434. Per the block 405, the perforator 460 may be activated to form additional perforations in the casing 440 (e.g., second stage perforations) as well as channels 415-2 in the layer 414 (e.g., second stage channels). Per the block 406, fluid may be introduced while the plug 470 is disposed in the bore 430, for example, to isolate a portion of the bore 430 such that fluid pressure may build to a level sufficient to form fractures 417-2 in the layer 414 (e.g., second stage fractures).

In a method such as the method 400 of FIGS. 4 and 5, it may be desirable that a plug (e.g., the plug 470) includes properties suited to one or more operations. Properties of a plug may include mechanical properties (e.g., sufficient strength to withstand pressure associated with fracture generation, etc.) and may include one or more other types of properties (e.g., chemical, electrical, etc.). As an example, it may be desirable that a plug degrades, that a plug seat degrades, that at least a portion of a borehole tool degrades, etc. For example, a plug may be manufactured with properties such that the plug withstands, for a period of time, conditions associated with an operation and then degrades (e.g., when exposed to one or more conditions). In such an example, where the plug acts to block a passage for an operation, upon degradation, the passage may become unblocked, which may allow for one or more subsequent operations.

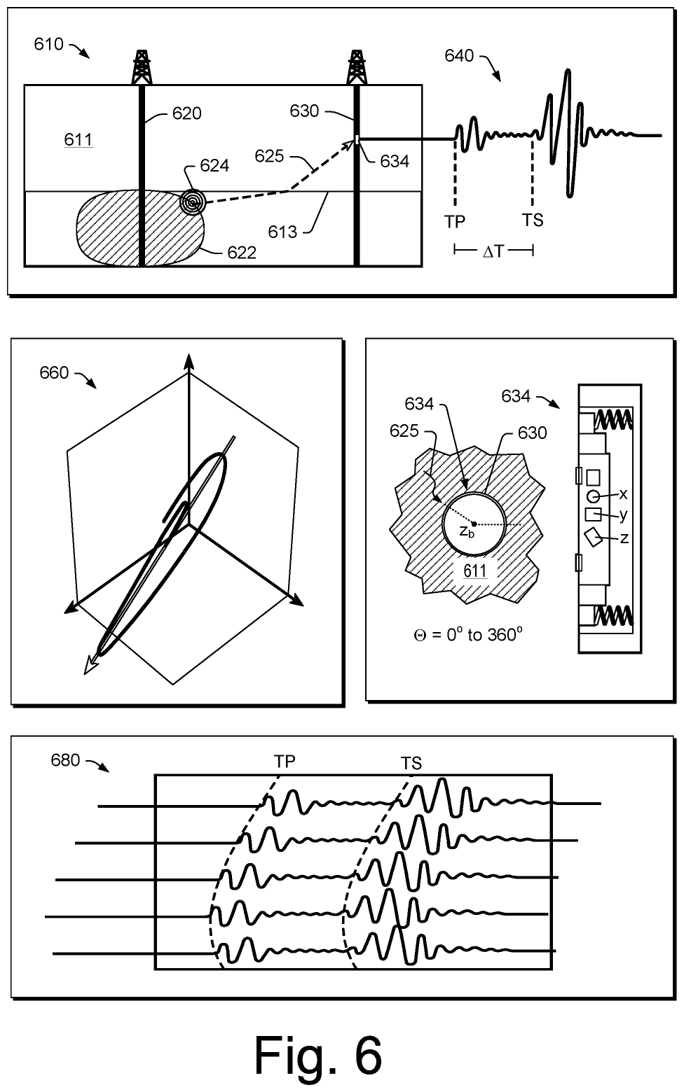

FIG. 6 shows an example of a microseismic survey 610, which may be considered to be a method that implements equipment for sensing elastic wave emissions of microseismic events (e.g., elastic wave energy emissions caused directly or indirectly by a treatment). As shown, the survey 610 is performed with respect to a geologic environment 611 that may include a reflector 613. The survey 610 includes an injection bore 620 and a monitoring bore 630. Fluid injected via the injection bore 620 generates a fracture 622 that is associated with microseismic events such as the event 624. As shown in the example of FIG. 6, energy 625 of a microseismic event 624 may travel through a portion of the geologic environment 611, optionally interacting with one or more reflectors 613, and pass to the monitoring bore 630 where at least a portion of the energy 625 may be sensed via a sensing unit 634, which may include a shaker, three-component geophone accelerometers isolated from a sensing unit body (e.g., via springs, etc.), coupling contacts, etc. In the example of FIG. 6, the sensed energy includes compressional wave energy (P-wave) and shear wave energy (S-wave).

As shown in the example of FIG. 6, one or more sensors of the sensing unit 634 can be oriented in the monitoring bore 630 with respect to the position of the microseismic event 624 and/or the energy 625 as received by at least one of the one or more sensors of the sensing unit 634. As an example, the orientation of a sensor may be defined in a coordinate system or coordinate systems such that orientation information may be defined as to one or more microseismic events and/or energy received as associated with one or more microseismic events. FIG. 6 shows an approximate diagram of a cross-sectional view of the sensing unit 634 in the monitoring bore 630 of the geologic environment 611 where energy 625 is arriving at the sensing unit 634 at an angle Θ, which may be defined in a range of angles from approximately 0 degrees to approximately 360 degrees (e.g., where 0 and 360). As an example, a monitoring system may include one or more types of sensors. For example, consider downhole sensors and surface sensors. As an example, monitoring may be performed using surface sensors optionally without a monitoring bore with downhole sensors.

In FIGS. 1 and 3, various examples of machines can include one or more processors, memory, interfaces, etc. For example, the monitoring equipment 302 (e.g., a truck, etc.), the equipment 304 (e.g., a truck, etc.) and the remote facility 306 can include one or more processors, memory, interfaces, etc. As an example, a vehicle and/or a trailer may include wheels and an engine and/or a motor and one or more processors, memory, interfaces, etc.

As mentioned, a field operation can include using one or more pump systems. As an example, a pump system can include an internal combustion engine that is operatively coupled to a transmission that is operatively coupled to a pump that can pump fluid. As an example, such a pump system may be carried by a vehicle or a trailer.

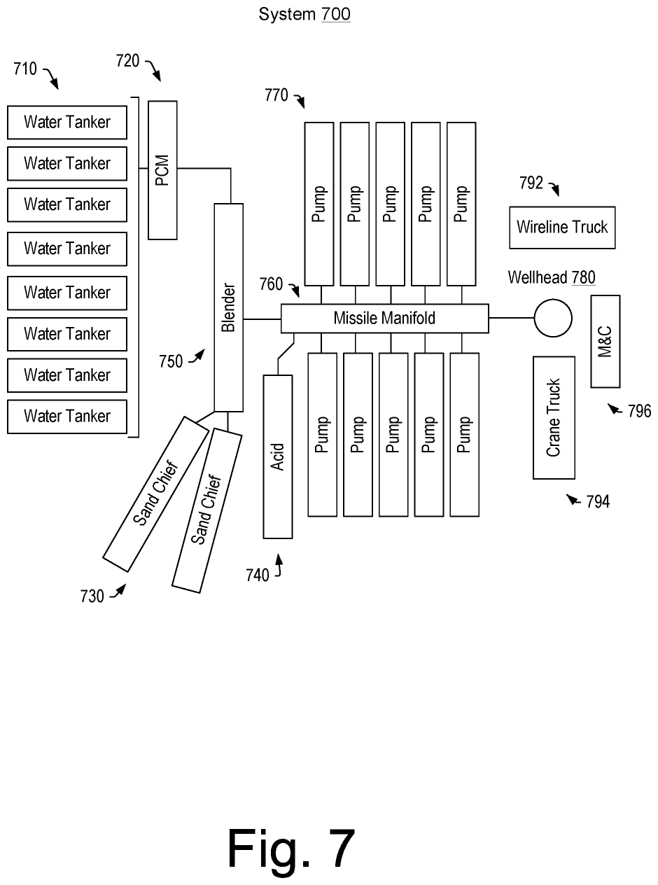

FIG. 7 shows an example of a system 700 that includes water tankers 710, a precision continuous mixer (PCM) 720, one or more sand chiefs 730, an optional acid and/or other chemical supply 740, a blender 750, a missile manifold 760, and a fleet of pump systems 770. The pump systems 770 are operatively coupled to the missile manifold 760, which is supplied with fluid via at least the PCM 720 and the blender 750, which may receive fluid from one or more of the water tankers 710, which can include conduits operatively coupled via a manifold or manifolds. As shown, the system 700 can provide for output of blended fluid, optionally with solids (e.g., sand as proppant, etc.) and optionally with chemicals (e.g., surfactant, acid, etc.), to a wellhead, which is a wellhead 780 to at least a partially completed well (e.g., with one or more completion components). As an example, one or more operations may be performed as explained with respect to, for example, FIGS. 3, 4, 5 and 6. For example, hydraulic fracturing can be performed using the system 700. At the wellhead 780, various types of equipment may be present such as a wireline truck 792, a crane truck 794 and monitoring and/or control (M&C) equipment 796.

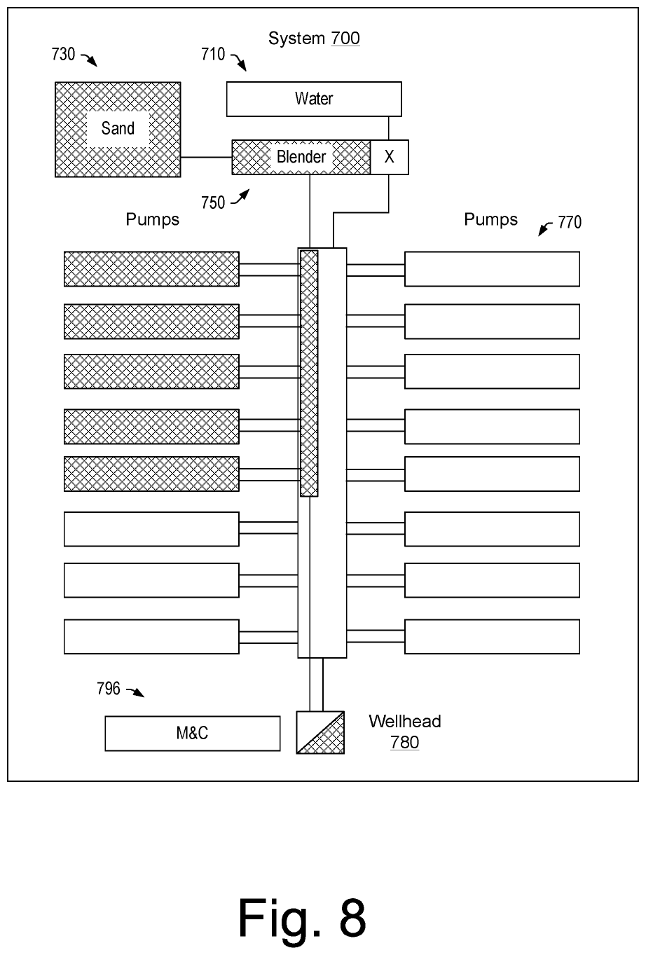

FIG. 8 shows another example of the system 700 that includes various pumps 770 (e.g., pump systems). As shown, the blender 750 can handle sand (e.g., proppant) as may be supplied by the one or more sand chiefs 730 and water as may be supplied by one or more water tankers 710 where the pumps 770 can direct a slurry to the wellhead 780.

FIGS. 7 and 8 show the monitoring and control equipment (M&C) 796, which may be or include equipment such as the FracCAT equipment (Schlumberger Limited, Houston, Texas). The FracCAT equipment (a fracturing computer-aided treatment system) includes hardware and software for monitoring, controlling, recording and reporting various types of fracturing treatments. Its real-time displays, plots, surface schematics and wellbore animations present information of a treatment as it occurs, which can provide for decision making using real-time detailed job information from the surface to the perforations. As an example, a framework such as the FracCADE framework (Schlumberger Limited, Houston, Texas) may be utilized, which includes various components for fracture design and evaluation. Such a framework may, for example, be integrated with or otherwise accessible via the DELFI environment.

During a job, M&C equipment can track job parameters, which may be compared to planned values. M&C equipment can use design specifications to control proppant and additive concentrations in one or more blenders. M&C equipment may be operatively coupled to a local area network (LAN) environment, for example, to allow for networking of equipment at a wellsite and provide a connection to the Internet (e.g., through satellite or cellular telephone technology). As an example, Internet connectivity can provide an ability to transmit real-time data from a wellsite to one or more locations (e.g., for real-time analysis, etc.).

As explained, various types of equipment can perform various types of field operations. As an example, a controller can be operatively coupled to one or more types of equipment. For example, consider automotive equipment, airline equipment, engines, transmissions, mining equipment, material handling equipment, construction equipment, rotating equipment, etc.

As an example, a controller can include or be operatively coupled to a machine learning framework that includes one or more machine learning models. As an example, a multiple linear regression model (MLR model) can be a machine learning model (ML model). As an example, an artificial neural network (ANN) model can be a machine learning model (ML model). As an example, a trained ML model may be implemented for controlling equipment.

As an example, a ML model can be a physics-based ML model and/or include one or more physics-based models. As an example, a ML model can be relatively light-weight, which may expedite learning and/or reduce computational resource demand to generate a trained ML model or ML models.

As to types of machine learning models, consider one or more examples such as a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network (CNN), stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model, may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange on various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. For example, one or more pieces of equipment at a wellsite may include and/or utilize a lightweight framework suitable for execution of a machine learning model (e.g., a trained ML model, etc.). TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, data processing, image classification, object detection, pose estimation, question answering, text classification, etc., on multiple platforms.

As an example, field equipment may include one or more processors, cores, memory, etc., which may be deployed as a “box” or integrally to be locally powered and that can communicate locally and/or remotely with other equipment via one or more interfaces. As an example, one or more pieces of equipment may include computational resources that can be akin to those of an AGORA gateway or more or less than those of an AGORA gateway. As an example, an AGORA gateway may be a network device.

As an example, one or more pieces of field equipment can include one or more features of an AGORA gateway (e.g., v.202, v.402, etc.). For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in. As an example, such a computing device may include a framework, which may be a lightweight framework (e.g., TFL, etc.).

As an example, a classification tree approach may be utilized to generate a result for given inputs. As an example, a random forest approach may be utilized to grow many classification trees. As an example, a method can include classifying a new object from an input vector by putting the input vector down each of the trees in a forest. In such an example, each tree can provide a classification where a tree can “vote” for a class. In a forest, the forest chooses the classification having the most votes (e.g., given the votes of the trees in the forest).

As an example, a tree can be grown using a number of cases in a training set, N, by sampling N cases randomly, with replacement from the original data. The sample can be a training set for growing a tree. If there are M input variables, a number m<<M can be specified such that at each node, m variables are selected at random out of the M and the best split on these m is used to split the node. The value of m can be held constant during the forest growing. As an example, each tree can be grown to a largest extent possible (e.g., without pruning).

Forest error rate can depend on various factors such as, for example, the correlation between two trees in the forest where increasing the correlation increases the forest error rate; and strength of each individual tree in the forest where a tree with a low error rate can be a strong classifier and where increasing the strength of the individual trees decreases the forest error rate.

As an example, reducing m can reduce both the correlation and the strength; whereas, increasing m can increase both. For random forests, somewhere in between is an optimal range of m. Using an out-of-bag (oob) error rate, a value of m in the range can be found, which may be an adjustable parameter to which random forests can be somewhat sensitive.

Features of a random forest can include efficiency on large sets of data, estimates of variables are particularly notable for classification, generation of an internal unbiased estimate of the generalization error as the forest building progresses, effective handling of missing data via estimating missing data (e.g., including maintaining accuracy when a relatively large proportion of data may be missing), an ability to balance error in class population unbalanced data sets, ability to use on other data, understanding of relation between the variables and the classification, computation of proximities between pairs of cases (e.g., for use in clustering, locating outliers, etc.), ability to use scaling to provide various views of data, ability to extend to unlabeled data (e.g., leading to unsupervised clustering, data views and outlier detection), and providing an experimental method for detecting variable interactions.

As mentioned, an example of a machine learning model is a neural network (NN) (e.g., a neural network model), which can include neurons and connections where each connection provides the output of one neuron as an input to another neuron. Each connection can be assigned a weight that represents its relative importance. A given neuron can have multiple input and output connections. A NN can include a propagation function that computes the input to a neuron from outputs of its predecessor neurons and their connections as a weighted sum. As an example, a bias term can be added to the result of the propagation.

As an example, neurons can be organized into multiple layers, particularly in deep learning NNs. As an example, the layer that receives external data can be an input layer and the layer that produces a result or results can be an output layer. As an example, a NN may be fully connected where each neuron in one layer connects to each neuron in the next layer. As an example, a NN can utilize pooling, where a group of neurons in one layer connect to a single neuron in the next layer, thereby reducing the number of neurons in that layer. As an example, a NN can include connections that form a directed acyclic graph (DAG), which may define a feedforward network. Alternatively, a NN can allow for connections between neurons in the same or previous layers (e.g., a recurrent network).

A recurrent neural network (RNN) is a class of artificial neural networks where connections between nodes can form a directed graph along a temporal sequence. Such features can allow a RNN to exhibit temporal dynamic behavior. RNNs can use their internal state (memory) to process variable length sequences of inputs. RNNs can include various classes of networks such as finite impulse and infinite impulse, both of which can exhibit temporal dynamic behavior. A finite impulse recurrent network can form a directed acyclic graph that can be unrolled and replaced with a strictly feedforward neural network, while an infinite impulse recurrent network can form a directed cyclic graph that cannot be unrolled.

Finite impulse and infinite impulse recurrent networks can have additional stored states, and the storage can be under direct control by the neural network. The storage can also be replaced by another network or graph, if that incorporates time delays or has feedback loops. Such controlled states can be referred to as gated state or gated memory and can be part of long short-term memory networks (LSTMs) and gated recurrent units.

A convolutional neural network (CNN) can include an input and an output layer, as well as multiple hidden layers. The hidden layers of a CNN can include a series of convolutional layers that convolve with a multiplication or other dot product. An activation function can be a RELU layer and can be subsequently followed by one or more additional convolutions such as pooling layers, fully connected layers and normalization layers, referred to as hidden layers because their inputs and outputs are masked by the activation function and final convolution. Layers can provide for a sliding dot product or cross-correlation, which can affect indices in a matrix, in that it affects how weight is determined at a specific index point.

As an example, a trained ML model (e.g., a trained ML tool that includes hardware, etc.) can be utilized for one or more tasks. As an example, various types of data may be acquired and optionally stored, which may provide for training one or more ML models, for retraining one or more ML models, for further training of one or more ML models, and/or for offline analysis, etc.

As an example, the CARET (Classification And REgression Training) package may be utilized, which includes tools for data splitting, pre-processing, feature selection, model tuning using resampling, variable importance estimation, etc. The CARET package includes various different modeling functions in R (R-package). Some have different syntax for model training and/or prediction. In the R-package, a method can include utilizing a library “tidyverse”.

FIG. 9 shows an example of a system 900 that can provide for generation of one or more graphical user interfaces 910 and 920. As shown, the GUI 910 shows a geographic region with basins, plays and prospective regions. As an example, a system may include features that are tailored to one or more geographic regions. For example, a system can include one or more trained machine learning models that are trained using data from a particular region or, for example, a particular region and one or more analogue regions.

As an example, a reservoir may be characterized as being unconventional. The phrase unconventional resource may be utilized as an umbrella phrase for oil and natural gas that is produced using techniques, technologies, etc., that in one or more ways differ from those of so-called conventional production. Unconventional resource characteristics may depend on available exploration and production technologies, economic environment, and scale, frequency and duration of production from the resource. As an example, the phrase unconventional resource may be utilized to reference oil and gas resources whose porosity, permeability, fluid trapping mechanism, or other characteristics differ from conventional sandstone and carbonate reservoirs. As an example, coalbed methane, gas hydrates, shale gas, fractured reservoirs, and tight gas sands can be considered unconventional resources.

Unconventional reservoirs represent a considerable amount of energy resources, examples being organic-rich shales like the Eagle Ford, Bakken, Haynesville, Marcellus, etc. (see, e.g., the GUI 910). Due to their relatively low permeability, hydraulic fracturing can be performed to increase paths for flow of fluids, which can make production of hydrocarbons from such resources more practical.

In FIG. 9, the GUI 920 corresponds to operations performed in the Eagle Ford play, which is sometimes referred to as the Eagle Ford Shale. The Eagle Ford Shale is a hydrocarbon-producing geological formation with capability of producing both natural gas and oil. The Eagle Ford Shale has an average thickness of approximately 250 feet within Railroad Commission of Texas (RCT) Districts 1-6. A relatively high percentage of carbonate tends to make it more brittle and therefore more conducive to hydraulic fracturing. The Eagle Ford Shale is Cretaceous in age resting between the Austin Chalk and the Buda Lime.

As mentioned, the thickness can, in various regions, be measured in feet such as several hundred feet. Thus, regions may be laterally extensive and relatively “thin”. Directional drilling can be employed where a driller can aim to drill a borehole within a relatively thin lateral region. Such drilling or borehole may be referred to as horizontal, for example, as opposed to vertical. Operations performed in lateral boreholes can differ from those performed in vertical boreholes due in part to the influence of gravity. For example, gravity may help a drillstring move deeper vertically while gravity acting on a horizontal drillstring may increases drillstring and borehole wall friction such that sticking dynamics differ from those that may be experienced for vertical drilling. Gravity may also act upon particles in a slurry. For example, in a vertical borehole, particles may move vertically downhole under the influence of gravity while, in a horizontal borehole, particles may move vertically to settle along a borehole wall under the influence of gravity.

In the example GUI 920 of FIG. 9, a plot of data versus time is shown for a stage X and a stage X+1, which are successive stages of hydraulic fracturing operations in the Eagle Ford Shale. Specifically, the plot shows treatment pressure (TP) with a scale ranging from 0 psi to 10,000 psi, slurry rate (SR) with a scale ranging from 0 bbl/m to 100 bbl/m, and proppant concentration (PC) as injected and at bottomhole (BH) with a scale ranging from 0 lbm/gal to 10 lbm/gal. As indicated, each of the two stages includes operations performed over a period of time of approximately 1.5 hours where proppant is provided over a period of time of approximately 1 hour. Two operational events are also indicated: pill hits perforations followed by shut-in.

As an example, wells may be completed in high-pressure, high-temperature (HPHT) areas with fracturing gradients of 0.85-0.95 psi/ft (e.g., approximately 0.19-0.21 bar/m), total vertical depths (TVDs) of 12,000-13,500 ft (e.g., 3658-4115 m), and bottomhole temperatures ranging from 300 degrees F. to 345 degrees F. (approximately 149-174 degrees C.). Various completions can be based on a plug-and-perf technique, with four to eight perforation clusters per interval isolated by bridge plugs.

Field operations can include stimulation and/or restimulation. For example, consider restimulation of an existing well where an aim may be to accelerate and increase the estimated ultimate recovery (EUR) of oil and gas by reestablishing conductivity in existing (“old”) hydraulic fractures and stimulating new reservoir volume. Restimulation can become more desirable as existing wells in a play age.

Refracturing operations can aim to provide effective stimulation/restimulation along a length of a well, which may be more than 1,000 feet (approximately 333 m) in length (e.g., consider 4,000 ft (approximately 1333 m) to 6,000 ft (approximately 2000 m) or more). As perforations are open in an existing well, mechanical aids such as bridge plugs cannot be readily used.

As an example, one or more fracturing services may be implemented as part of refracturing operations. For example, consider a service that delivers temporary isolation of clusters through engineered application of a degradable composite fluid that includes a blend of degradable particles and fibers.

As an example, refracturing may be performed after a year or several years of production. For example, consider performing hydraulic fracturing in a well, producing from the well for a number of years, and then refracturing in an effort to increase production (e.g., production rate and/or total recovery). In the example plot of the GUI 920, refracturing operations included 13 fracturing stages, which were completed using an amount of proppant from the first stimulation campaign as well as the HiWAY flow-channel hydraulic fracturing technique. The refracturing operations included pumping of composite pills between fracturing stages to provide for temporary isolation of previously stimulated clusters. Further, a shut-in was applied after placing each composite pill to monitor changes in fracturing gradient. As indicated in the plot of the GUI 920, a composite pill is pumped in between, followed by a pump shut-in to measure initial shut-in pressure (ISIP).

The 13 refracturing stages were pumped sequentially in 36 hours and without use of mechanical aids such as bridge plugs or inflatable packers. Initial shut-in pressure (ISIP) measurements captured at the end of each stage showed progressive increase toward values that are characteristic of previously untreated rock in the area. Thus, the refracturing services helped to reinvigorate and isolate depleted areas while enabling stimulation of undeleted areas of the lateral well.

After the refracturing operations, the well was put in production using a smaller choke ( 8/64 inch or approximately 0.3175 cm) than the one used prior to restimulation (10/64 inch or approximately 0.4 cm). Results over the first 45 days after restimulation showed that, despite the increased restriction, oil and gas production rates doubled while tubing pressure increased fourfold. Calculations for the well's productivity index (PI), which took into account both rates and pressures to normalize production, indicate an increase in PI of more than 600 percent after the restimulation operation.

As explained, the GUI 920 can be part of a system that generates, analyzes and issues control actions. For example, a control action may be to adjust an amount of proppant, adjust a slurry rate, etc. Where an operation may be performed over a period of time that is more than a minute, an operator may view real-time data and make one or more adjustments with an effort to improve the operation. However, a single operator, in view of real-time data, may be able to hypothesize a rather limited number of control scenarios at a given time (e.g., one or two scenarios). As an example, a system may provide for generating more than one control scenario in real-time. For example, consider a system that can generate ten control scenarios and analyze such control scenarios to determine which of the control scenarios is worth considering for actual implementation. In such an example, the system may in a relatively continuous manner output one or more control scenarios, optionally ranked, to a GUI and/or control equipment, such that one or more operations can be possibly improved in an iterative manner. In such an example, an operator may be free to think of what he may do and be able to view what the system would do. In such an example, the operator may issue control actions manually, semi-automatically or automatically. For example, the operator may think his recommendation is the best and implement it manually by interacting with a controller to control equipment, the operator may think a system generated recommendation is best and implement it by hitting an issuance graphical control (e.g., a button, etc.), or the operation may think system generated recommendations are suitable and allow the system to automatically issue one or more non-conflicting control actions (e.g., consider a top ranked recommendation as not being compatible with a second ranked recommendation such that the system assures that one of the two is implemented and not both).

As an example, a trained machine learning model may be trained using data from one or more prior operations associated with one or more offset wells as offset from a particular well and then utilized for one or more operations associated with the particular well. As an example, a trained machine learning model may be trained using data from one or more prior operations associated with a well and/or one or more offset wells and then utilized for one or more additional operations associated with the well.

As an example, a system can be implemented to include an assessment phase where trained machine learning model predictions are assessed for a number of initial stages to determine whether the trained machine learning model is suitable for use in generating control actions for one or more subsequent stages. For example, in the foregoing example of FIG. 9, consider the first three stages as being assessment stages while the subsequent 10 stages may be considered stages guidable by trained machine learning model predictions. In such an example, consider the predictions being for treatment pressure (e.g., treating pressure). Where predictions for treatment pressure match actual treatment pressure measurements for the first three stages, then the system may be utilized with some assurances that its trained machine learning model can adequately model physical phenomena associated with the well and operations for the well.

As explained, decisions taken during a stimulation treatment may be made by the personnel at a wellsite. Given the dynamics of the stimulation treatment, such personnel may not be able to calculate costs, efficiency changes, or other improvements in real-time. Experience can be a factor such that a more experienced operator can utilize previous experience to make recommendations on how to change the stimulation treatment based on one or more well parameters. However, even an experienced operator can be limited in her ability to consume real-time data and discern beneficial control actions in a timely manner. As such, a system that can generate real-time control actions for stimulation treatments can improve such operations, moving them to a more optimal space (e.g., improved efficiency, lesser costs, better outcomes, etc.).

As an example, a system may utilize statistical learning and data sources to provide for real-time optimization of one or more stimulation treatments. For example, consider a system that can identify conditions and/or anomalies that will impact the amount of materials pumped and/or the time to complete a treatment. Such a system can allow personnel to optimize decision making and better understand how surface changes are impacting overall performance of the treatment.

As an example, a system can utilize one or more feature extractors. For example, consider a feature extractor that is trained using one or more of a regression building approach, a neural network approach and reinforcement learning to determine if one or more conditions exist during a stimulation treatment where wellbore parameters may be adjusted to optimize performance. In such an example, training can be achieved using one or more historic databases of stimulation treatments. For example, consider training of one or more machine learning models (e.g., optionally an ensemble of models) to predict one or more future states of one or more wellbore parameters. As explained with respect to the example of FIG. 9, the system 900 may utilize a database or databases for one or more different geologic regions. For example, a system may be trained for performing stimulation operations in the Eagle Ford Shale using data acquired from prior stimulation operations in the Eagle Ford Shale. Where a region does not include a sufficient amount of pre-existing data, the system 900 may utilize data and/or one or more models from another region, which may be deemed to be sufficiently analogous. As mentioned, the system 900 may implement an assessment phase, for example, for an initial number of stages. In such an example, where the system 900 utilizes a trained ML model that was trained using analogue data, the assessment phase provides for some assurances as to whether or not the data are sufficiently analogous. Decision making as to analogue data as training data may assist further training. For example, where data are found to be sufficiently analogous to generate a suitable trained ML model, the system may make note of the analogy for purposes of additional training of one or more ML models.

As an example, a system can include a plurality of ML models, which may be for particular purposes. For example, consider a plurality of ML models that can form an ensemble for predictions underlying a group of real-time control actions or a plurality of ML models that can form an ensemble for predictions underlying a particular type of real-time control action. As an example, a system can provide for real-time parametrized cost optimization while executing a hydraulic fracturing process. As an example, a system may perform multi-agent hypothesis testing for the purpose of hydraulic fracturing cost optimization in real-time. While the term “cost optimization” is utilized, objective function optimization may be utilized. For example, a cost function may be a type of objective function where upon optimization, a lowest cost of resources, time, etc., is a result. As an example, an objective function or objective functions may aim to capture efficiency or efficiencies of an operation. For example, consider a more efficient operation as being one that can be adequately performed using lesser of a resource or lesser resources. As mentioned, energy, materials, time, labor, etc., can be types of resources.

As an example, a cost function may be an objective function where an aim is to minimize a value or values of the cost function (e.g., minimal cost). As an example, a loss function or an error function may be an objective function where an aim is to minimize a value or values. As an example, a loss function may be a part of a cost function which may be a type of an objective function.

As an example, a loss function may be a function defined on a data point, prediction, and label, and measure a penalty. For example, consider a square loss as used in linear regression, a hinge loss as used in a support vector machine (SVM), or a 0/1 loss as used in theoretical analysis and definition of accuracy.

As an example, a cost function may be a sum of loss functions over a training set plus some model complexity penalty (e.g., regularization). For example, consider mean squared error (MSE), a support vector machine (SVM) cost function, etc.

As an example, an objective function can be a function that is aimed to be optimized during training. For example, a probability of generating a training set in a maximum likelihood approach can be a well-defined objective function, though it may not strictly be a loss function nor a cost function. For example, consider a MLE as a type of an objective function that may be maximized, divergence between classes, etc.

As to an error function, for example, consider backpropagation or automatic differentiation as may be utilized by the gradient descent optimization algorithm to adjust the weight of neurons by calculating the gradient of the loss function. Such a technique is also sometimes referred to as backward propagation of errors because the error is calculated at the output and distributed back through the network layers.

As an example, a system can be a hybrid framework for optimizing the cost of a stimulation treatment in real-time. Such a system can include a recommender engine and a pumping bot (Bot) that looks in real-time for opportunities to optimize cost of a stimulation treatment (e.g., as accomplished through pumping). For example, the Bot can be assessing a hypothesis of a treatment cost optimization scenario, for example, from a predefined list of control actions. Such hypotheses can be tested through an algorithm to predict the cost function and minimize the total cost of treatment stage. In such an example, if the hypothesis has a positive result (e.g., lesser cost), it can be transmitted to/received by the recommender engine. The recommender engine can assess the hypotheses for one or more possible violations of one or more rules, which may include one or more safety rules, treatment quality guidelines (quality assurance (QA) test), etc. If a hypothesis, which can be a control action, passes the recommender engine successfully (e.g., passes rule test(s), QA test(s), etc.), the Bot can issue the hypothesis, which may be a control action, to a controller, a computer, etc. For example, consider issuing a control action to a computer that can render a GUI to a display where a user can interact with the GUI to control a stimulation treatment. As an example, a quality assessment may provide for determining whether a control action or control actions are valid (e.g., do not violate one or more criteria, etc.).

As explained, an objective function or objective functions may be utilized where a cost function is a type of objective function. For example, consider a cost function that includes two types of variables, ones that are defined by design (e.g., fixed costs) and ones that can be variable during an execution phase (e.g., variable costs).

As an example, a system can include performing variable cost optimization, which may be coupled to one or more controllers for real-time treatment simulation to allow for real-time treatment design adjustments (e.g., pad volume, proppant ramp, proppant concentration, etc.), which can provide for actual adjustments in cost.

As an example, a cost function may be expressed as follows:

cost=C(f₁, . . . ,fᵢ,v₁, . . . ,vᵢ)

where fixed costs, f, may include personnel fees, sand, cleanfluid, etc., and where variable costs, v, may include chemicals, per hour usage, etc.

As an example, consider Cost=C(chemical fee, personnel fee, per hour equipment usage fee, HHP usage fee, cleanfluid fee per bbl, sand).

As an example, unit quantities and unit costs can be utilized to represent relative values of resources expended in an effort to produce fluid. As an example, a systems approach may be utilized that includes energy and/or materials expended versus energy and/or materials recovered. For example, one barrel of crude oil may be equated to approximately 6.2 gigajoules. If the energy expended to produce one barrel of crude oil exceeds 6.2 gigajoules, then, from a systems perspective, the process of producing that one barrel of crude oil is not energy-wise economical.

As an example, one or more databases such as pricebook databases may be utilized to equate unit quantities with unit costs. For example, consider a coded database with entries for equipment and services such as one or more of pumped clean fluid charge per bbl, engineer support per stage, frac spread rental per hour, pumped proppant charge per lb, and fracturing pump service charge for hydraulic horsepower (HHP) per hour, and/or with entries for materials such as one or more of water friction reducing agent (FR), scale inhibitor, dry high viscosity friction reducer, breaker, sand and activator.

As explained, various types of additives may be utilized in a stimulation treatment. As mentioned, one type of additive may help to reduce friction and be referred to as a friction reducer (FR). Friction reducers can include long-chain polyacrylamides (PAM) in dry powder and liquid forms that can be added in a desired concentration range (e.g., consider a range of 0.5 to 2 gallons per thousand (gpt) (e.g., 1.9 to 7.6 liter per thousand)) to water to make “slickwater”. PAMs for unconventional reservoirs tend to be classified into three categories: anionic, nonionic, and cationic. FRs may also be classified as hydrophobic and amphoteric. As an example, a maximum reduction of FRs may be obtained by dissolving one or more FRs into aqueous solution before injection as fracturing fluid. Friction reducers tend to have a relatively high dissolvability level in water, a high viscosity, and sufficient energy loss reduction.

As explained, fracturing operations can utilize water that is pumped at a high pressure to fracture rock such as shale. To reduce the loss of pressure from frictional forces, the water can be treated with various chemicals, which can include one or more friction-reducing additives. A friction reducer may be provided in a desired proportion (e.g., concentration, etc.), optionally mixed with one or more other chemicals (e.g., hydrochloric acid, NaCl, CaCl, KCl, brines, etc.).

As mentioned, treated water may be referred to as slickwater. In various scenarios, slickwater can increase the flow rate in a wellbore (e.g., from around 60 bbl/min to 100 bbl/min (approx. 9,500 l/min to 15,900 l/min), etc.). Chemicals in treated water can include friction reducers, biocides, scale inhibitors, etc. As to scale inhibitors, some examples include hydrochloric acid and ethylene glycol.

As an example, treated water may be referred to as fracturing fluid. As an example, additives can include a friction reducer and optionally one or more of a biocide, surfactant, breaker or clay control additive. Such fluid may have a relatively low viscosity of 2-3 cP, which can demand a relatively high pump rate to transport proppant. Small proppant size like 40/70 (40-70 mesh retained) may be utilized with such fluid due to its low viscosity and light weight proppant may be utilized due to its low proppant transport capability. Water frac tends to be the least damaging to a proppant pack and finds particular use in high efficiency tight gas wells.

Proppant size may be specified by mesh such as 40-70 mesh (e.g., 40/70) for indication of retained proppant. For example, consider mesh in a range from approximately 8 mesh to approximately 140 mesh (e.g., 106 μm to 2.36 mm), for example 16-30 mesh (e.g., 600 μm to 1180 μm), 20-40 mesh (e.g., 420 μm to 840 μm), 30-50 mesh (e.g., 300 μm to 600 μm), 40-70 mesh (e.g., 212 μm to 420 μm) or 70-140 mesh (e.g., 106 μm to 212 μm). As indicated, when describing frac proppant, sieve cut may be utilized (e.g., 20/40 proppant, etc.). For example, 20/40 may provide for a mean particle diameter of approximately 635 μm; whereas 30/50 may provide for a mean particle diameter of approximately 473 μm. As such, a larger number corresponds to a smaller size and a smaller number corresponds to a larger size.

Linear gel can be water containing a gelling agent like guar, HPG, CMHPG, or xanthan. Such a fluid can have a medium viscosity of 10-30 cP, which can result in improved proppant transport and, for example, wider frac. Medium proppant size like 30/50 may be utilized with such a fluid. Linear gel tends to be more damaging to a proppant pack than water frac; linear gel finds use in both gas and oil wells.

Crosslinked gel is water containing one or more gelling agents as may be used, for example, in linear gel and a crosslinker such as, for example, boron (B), zirconium (Zr), titanium (Ti) or aluminum (Al). A crosslinked gel fluid tends to have a relatively high viscosity of 100-1000 cP, which can result in better proppant transport and, for example, wider fracs. Larger proppant sizes like 20/40 and 16/30 may be utilized with such fluid. Crosslinked gel tends to be more damaging to a proppant pack than linear gel. Crosslinked gel can find use in oil and high liquid wells.

As an example, a stimulation treatment can include using hundreds of thousands of gallons of water and hundreds of thousands of pounds of proppant. Such materials can demand substantial pumping power to cause fracturing. As explained, various parameters can be controllable to achieved desirable fracturing where a real-time system can provide for optimization of resources (e.g., people, machinery, materials, energy, etc.).

As an example, each of the variables v₁ to vᵢ can have one or more corresponding calculation rules, which may be dependent on pumping parameters such as, for example, one or more of chemical concentration(s), rate, treating pressure, and pumping time.

As an example, a system can categorize treatment parameters, for example, consider the following two categories:
Controlled input parameters (x₁(t) . . . xᵢ(t)) (e.g., rate, chemicals concentration, proppant concentration, etc.); and
Output parameters (y₁(t) . . . yᵢ(t)) (e.g., treating pressure, friction pressure, etc.).

As an example, parameters x and y can include some interdependence such that a hybrid approach can be applied that utilizes multiple sources such as two or more of physics, lab correlations, and historical data within a model or models to predict the value of (y₁(t) . . . yᵢ(t)) where predicted values may be denoted with a prime such as y′ (e.g., y′₁(t) . . . y′ᵢ(t)). As an example, once predicted, these parameters can be passed to cost calculation rules to compute values of a cost function C(t) and total cost at the end of a stimulation treatment stage (T).

As mentioned, a cost function can be a type of objective function with an objective of minimizing a total stage cost (T), for example, by introducing adjustments to controlled input parameters (e.g., a hypothesis or control action) and recalculating C(t) in real-time, for example, with a frequency that may be predefined, based on real-time data acquisition rate(s), on-demand, etc.). As an example, a system can include a Bot that computes the cost function in real-time and tests discrete finite number of hypotheses (e.g., a number of control actions that may be suitable for implementation during the stimulation treatment).

For example, consider the following set of definitions and equations:

$$design = ( {x}_{1} … {x}_{i} )$$

$$hypothesis or control action = ( {x}_{1}^{′} … {x}_{i}^{′} )$$

$$T = {\int }_{t 0}^{tfinal} C ( {f}_{1} … {f}_{i} , {v}_{1} … {v}_{i} ) dt as normal cost of stage$$

$${T}^{′} = {\int }_{t 0}^{tfinal} C ( {f}_{1} … {f}_{i} , {v}_{1} … {v}_{i} ) dt as predicted$$

$$\frac{{T}^{′}}{T} < 1 , recommender condition$$

$$t 0 - time at the begining of the stage ,$$

$$tfinal - time at the end of the stage$$

As an example, consider a range of hypotheses bounded by input, which may be provided by default, equipment specifications, user input, etc. For example, consider: minQ=60 bbl/min, maxQ=100 bbl/min; minC(FR)=1.6 gpt, maxC(FR)=3.0 gpt.

As an example, a Bot can wait to test model accuracy if the model is accurately predicting parameters (y₁(t) . . . yᵢ(t)), after an introduction of a change, the Bot can recommend a second or a series of optimization steps, for example, based on a most recent algorithm run.

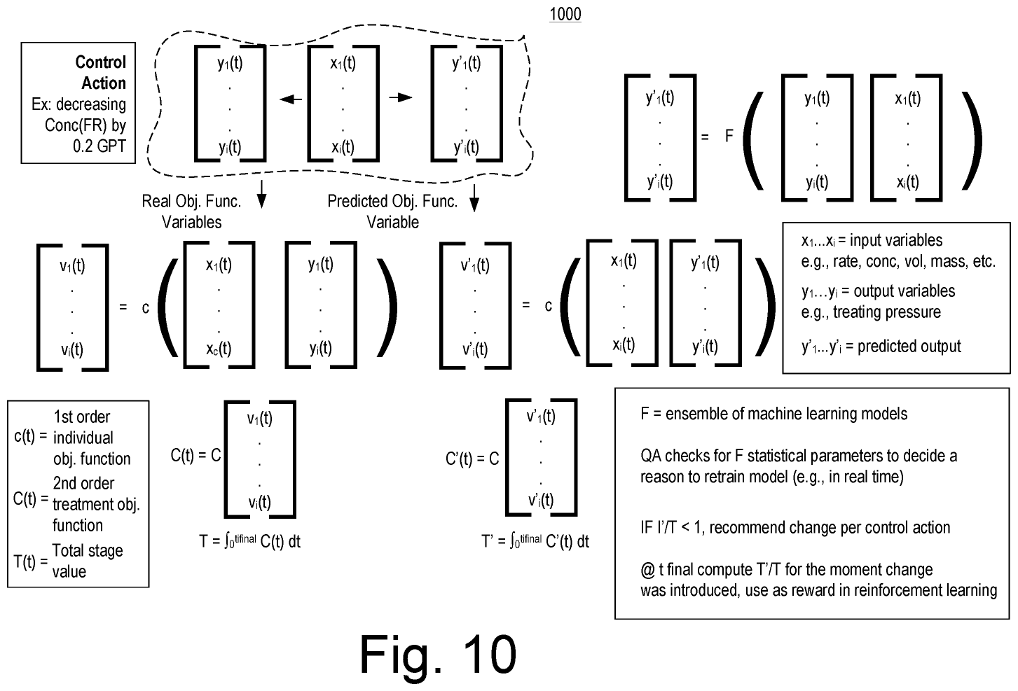

FIG. 10 shows an example of a schema 1000 that can be implemented by a system for issuance of control actions. In the example schema 1000, a control action may be, for example, “decrease Conc(FR) by 0.2 gpt”. Such a control action may be implemented using one or more pieces of field equipment. For example, consider one or more control valves that control flow of FR from a supply source (e.g., a tank of FR) into a fluid stream, which may be that of a mixer. As an example, FR may be pumped from a supply source where, from time to time, gas may be entrained in the FR (e.g., as a fluid) such that data may include indicia of gas entrainment, noise, etc.

In the example of FIG. 10, real objective function variables and predicted objective function variables are shown with respect to the hypothetical control action. As shown, F can be an ensemble of machine learning models where, for example, one or more quality assurance (QA) rules may be applied that can check F statistically to decide whether a reason exists to retrain a model, which may occur in real-time.

As an example, consider a hydraulic horsepower charge (HHPcost) that can be calculated as an average of Q(t) (pumping rate)*P(t) (treating pressure) where both Q and P are becoming second level variables of the cost function, which may be represented as follows:

$$HHP cost = \frac{{\sum }_{t 0}^{tfinal} Q * {\sum }_{t 0}^{tfinal} P}{tfinal * 40.8}$$

In such an example, v₁=HHPcost and v₂=FRcost, where FRcost is a cost of friction reducer (FR) chemical. By decreasing the friction reducer concentration, the cost of the treatment will be reduced, but a reduction in FR can cause an increase in the treating pressure therefore, increasing the HHPcost.

The foregoing example can be formulated in terms of a task where a cost optimization Bot can real-time test a FR concentration decrease hypothesis (e.g., control action) within a predefined range with a predefined increment (e.g., up/down by a particular amount, which may be with respect to time). If a predicted treatment cost T′ is then a designed treatment cost T within a given statistical error threshold, and satisfies QA criteria, the Bot can proceed by issuing the recommendation as a control action to reduce FR concentration.

As an example, a Bot or Bots can be testing multiple hypothesizes at the same time, in an effort to find possible ways to decrease the final variable of a total stage cost. As explained, a system may operate in a manner where a proven hypothesis (e.g., control action) will be transmitted to the recommender if it satisfies one or more criteria (e.g., safety, QA, etc.) and does not detrimentally affect the quality of the stimulation treatment. For example, if a friction reducer decrease may have an increase in HHP that may have a detrimental effect on a reservoir, a borehole, equipment, etc., then such a control action may be negated and not issued as a control action. As an example, one or more aspects of a fleet of pumps may be taken into account. For example, an increase in HHP may cause early maintenance to be triggered for one or more pumps (e.g., engines, transmission, pumps, etc.). In such an example, a control action may be negated, particularly if the early maintenance is to occur during a stage, which is not to be interrupted. If maintenance cannot be performed during the stage, then a failure may occur, which could detrimentally impact the stimulation treatment (e.g., an inability to reach a desired slurry rate, treatment pressure, etc.). Such a failure may, for example, result in damage to equipment and/or reservoir rock, which may hinder an ability to produce fluid from the reservoir rock.

As mentioned, a system can include one or more machine learning models. For example, predicted variables can be output by one or more trained machine learning models. For example, consider a neural network model, which may be trained using an engineered set of predictors based on physics and lab correlations and, for example, offset well data.

As to an example that includes a friction reducer, consider a system that predicts treatment pressure from a combination of types of parameters, including observed parameters/designed parameters and well/reservoir parameters. Some examples of the former can include rate, pressure, chemicals concentration, and proppant concentration and some examples of the latter can include flush volume to the middle of perforations, depth of the well to the middle of the perforations, average gamma ray log value in GAPI (American Petroleum Industry) as a proxy of formation stress, and number of per cluster, hole density and diameter. As an example, a positive bias model may be utilized as a safety measure for treatment prediction. As an example, parameters may be assigned with normalized weights based on one or more physics-based models and/or one or more lab correlations.

As an example, a system can include a flow engine that can compute friction pressure using fluid velocity, fluid density, dimension(s), etc. For example, consider a Reynolds number (Re) based approach that can include calculations based on perforations design and can output drag curves.

As an example, a flow engine can model fluid effective viscosity as growing sharply after a laminar-turbulent transition. In such an example, the flow of a hydraulic fracturing fluid in a borehole may be treated as tube flow and the flow of the hydraulic fracturing fluid in a fracture may be treated as a flat channel flow. In such a model, where the rate average value exceeds a critical value for the geometry and fluid properties (e.g., the Reynolds number exceeds the critical value), the flow mode can change from laminar to turbulent where the turbulent flow mode can be characterized by chaotic fluctuations of one or more flow parameters. Depending on specific field conditions, either laminar or turbulent mode may be desirable. As after a laminar-to-turbulent transition the flow friction losses increase, a power consumption of a pump fleet for injecting fluid into a borehole can increase substantially in the turbulent mode as compared to laminar mode. Consequently, measurement of pump power consumption with a smooth flow rate change, the moment when power consumption grows sharply may be determined. This power consumption jump can be an indicator of a borehole/fracture laminar-to-turbulent transition. In such an example, depending on the specific objectives, a control action may either continue at a set flow rate or, for example, reduce the flow rate to hinder transition to turbulent mode. As explained, borehole flow can impact drag where turbulence (e.g., Re>a transition value) may be taken into account to reduce risk of increasing hydrodynamic drag, which may cause a demand for increased HHP (e.g., number of pumps, pump gear shifts, pump energy consumption, etc.). As an example, a technique such as the technique described in U.S. Pat. No. 8,967,251, “Method of a formation hydraulic fracturing”, to Koroteev et al., issued Mar. 3, 2015, which is incorporated by reference herein, may be utilized. For example, such a technique may be utilized to establish a relationship between type of flow and pump data, which may be utilized to establish one or more relationships to drag.

As an example, drag may be computed and/or determined from data for a wall of a well, a wall of a fracture, proppant, etc. For example, consider a relationship between coefficient of drag (CD) and Re for flow past a sphere, which may be expressed visually as a log-log plot of Co versus Re. As an example, a Stokes law, Oseen law, Goldstein law, or another approach may be utilized for computation of drag.

As an example, a flow engine may be utilized to assist with control of treatment of low-permeable formations (e.g., shale gas fields, etc.), where relatively low-viscosity fracturing fluids with relatively large injection rates tend to be utilized.

As an example, a system can include one or more features, components, etc., for assessing accuracy of one or more predictive models, which can include one or more trained ML models. For example, consider a system that is implemented to train a model using offset wells historical data. In such an example, during execution of the first three stages of a stimulation treatment, the model can be fit using a current data set with current weights of the parameters. In such an example, a method can include creating accuracy metrics for the time series data prediction where, if the model accuracy is satisfactory based on QA parameters, the method can continue with one or more Bot recommendations; whereas, if the model accuracy is below the QA parameters, then the method can call for retraining the model based on the first observed x stages and test on consequent x stages. If the model testing QA is not passed, the method can continue with retraining on 2× stages and testing on next set of x stages and so on. In such an example, the number of stages to train and test can be dynamic, set by default, input by a user, based on specific model or model type, etc.

As an example, a system can provide for real-time fracturing treatment cost optimization via issuance of one or more control actions. As an example, a system can operate to gradually introduce changes to a pumping schedule to optimize total stage cost of one or more stages of a stimulation treatment(s). As an example, a system can provide for orchestration of predictors to fit hybrid and/or a data driven model for uncontrolled treatment parameter prediction (e.g., predicting treatment pressure). As an example, a method can include deciding model accuracy based on real-time fitting of treatment data as acquired during execution of a treatment.

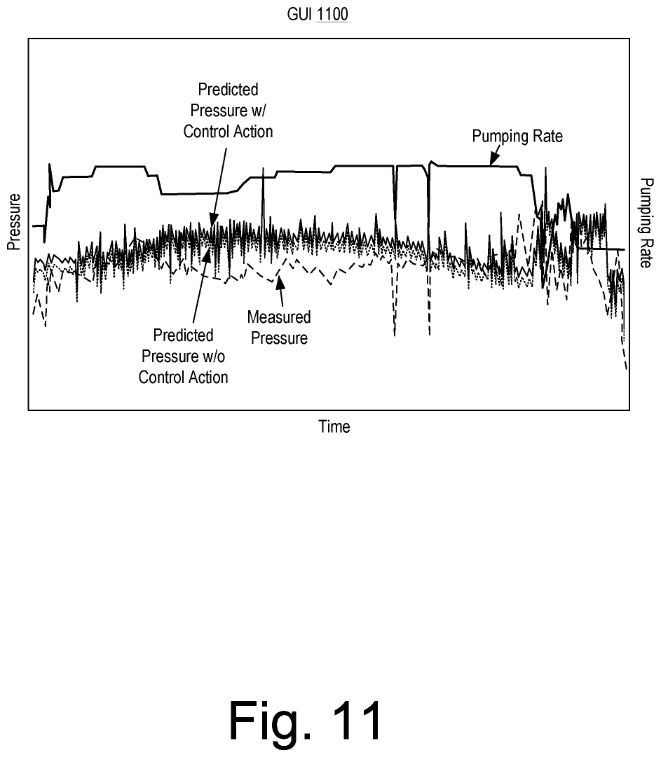

FIG. 11 shows an example of a GUI 1100 that includes a plot of treatment pressure and pumping rate versus time where treatment pressure includes measured treatment pressure, predicted treatment pressure without a control action and predicted treatment pressure with a control action such as, for example, utilizing a friction reducer (FR) concentration of 0.2 gpt. Over various times, acceptable agreement can exist between measured treatment pressure and predicted treatment pressure, which may provide for further analysis of a control action as a hypothetical control action that reduces cost (e.g., optimizes an object function or objective functions). As shown, the control action, if implemented, results in, over various times, a relatively small increase in treatment pressure. As such, it may be a viable control action that can be issued during execution of the stimulation treatment. While the plot of the GUI 1100 shows measured pressure and pumping rate across the entire time scale, portions thereof may be computed. For example, in a real-time scenario, the actual pumping rate and actual measured treatment pressure may be dynamic and represent a current time where data are yet to exist for future times, which can depend on implementation of one or more control actions (e.g., per a hypothesis or hypotheses).

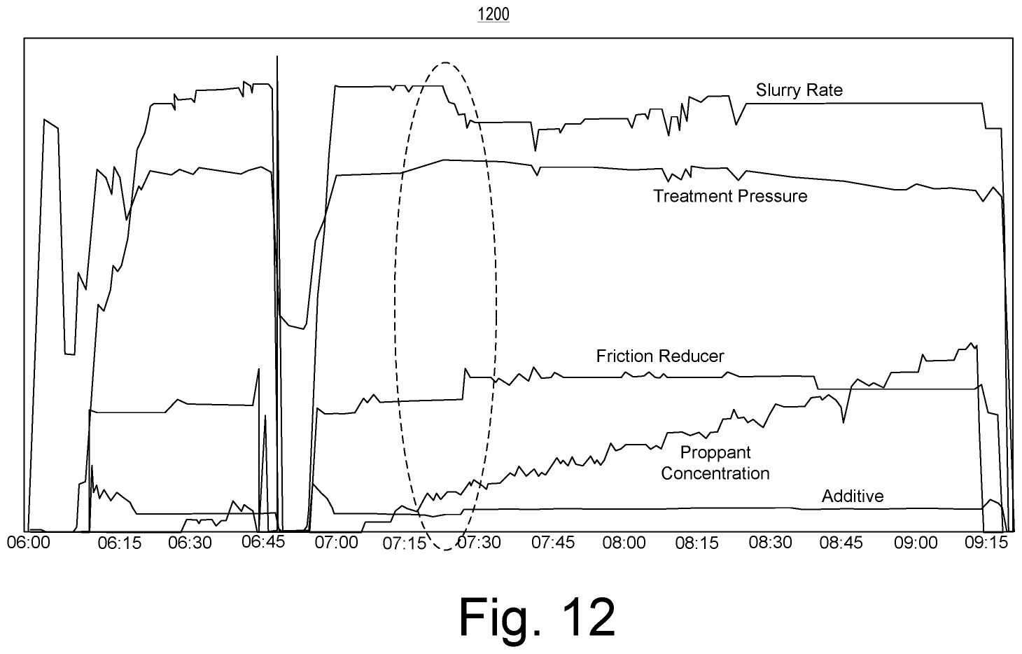

FIG. 12 shows an example of a GUI 1200 that includes a plot of treatment pressure, slurry rate, proppant concentration, friction reducer (FR) concentration and concentration of another additive with respect to time. The particular stage includes a relatively brief period between 6:45 and 7:00 where the slurry rate is reduced to approximately 0, noting that treatment pressure dips but does not have sufficient time to reach an equilibrium pressure as it increases once the prior slurry rate is reinstated. As shown, the FR concentration is ramped up and then drops with the slurry rate to be again ramped up with the slurry rate. At a time of approximately 7:05, which is after the slurry rate has reached a plateau, the proppant concentration begins to be gradually ramped upward (e.g., from approximately 7:05 to approximately 9:05). At a time of approximately 7:15, the treatment pressure starts to trend upward. As indicated, with some delay, the slurry rate is then incrementally reduced. For example, an operator or controller may detect the trending upward of the treatment pressure as being undesirable and try to reverse or halt the trend by reducing the slurry rate. Further, as an example, an adjustment may occur to the FR concentration. For example, at about 7:25, the FR concentration is increased. As a result of one or more of such control actions, the treatment pressure becomes relatively stable.

The data in the GUI 1200 illustrate some small deviations, which may be from noise, machine operations, etc. For example, shifting gears of a gear box on one or more pump engines of a pump fleet can be seen in data. As another example, gas may be entrained in fluid where FR is introduced and/or otherwise mixed into a fluid. As an example, a method can include monitoring control actions and/or indicia in data associated with such control actions for one or more purposes. For example, shifts in gears may be evidenced in treatment pressure data, which may provide an indication as to changes in a pump fleet that may have an impact on overall cost. As an example, a control action may be a relatively minor control action or a relatively major control action. For example, consider again the control action at approximately 6:45, which may be utilized to help divert fluid to particular clusters to improve a stage.

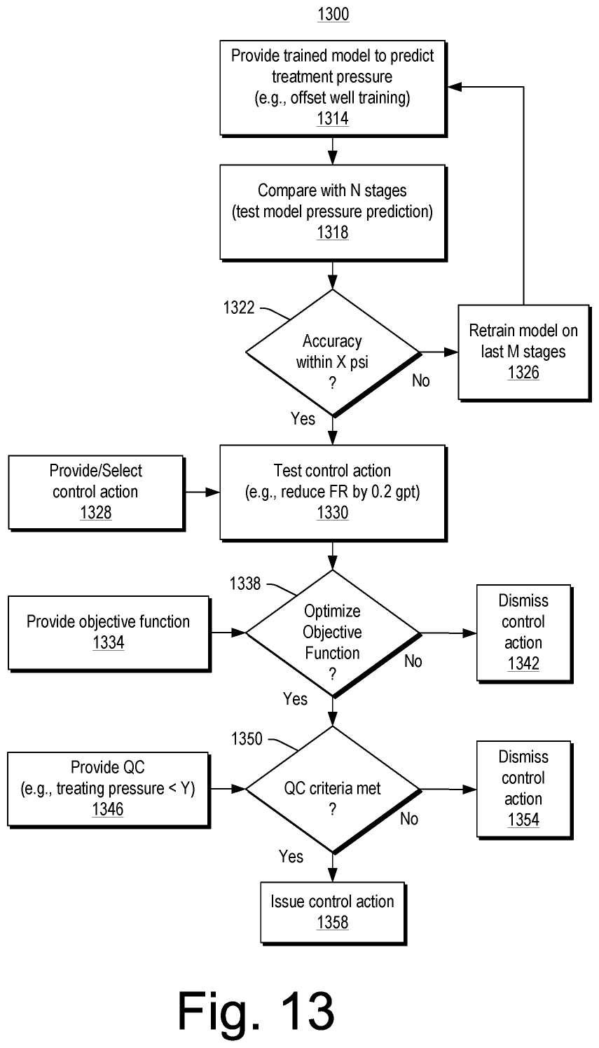

FIG. 13 shows an example of a method 1300 that includes a provision block 1314 for providing a trained model to predict treatment pressure (e.g., trained using offset well data and/or one or more other types of information), a comparison block 1318 for comparing predictions to actual data for N stages of a treatment process (e.g., N initial stages, etc.), a decision block 1322 for deciding whether accuracy (e.g., based on comparing) is within a threshold (e.g., X psi or Pa), a provision and/or a selection block 1328 for providing and/or selecting a control action, a test block 1330 following a “Yes” branch for testing of provided and/or selected control action (e.g., reducing FR by 0.2 gpt or equivalent in liters, etc.), a provision block 1334 for providing an objective function, a decision block 1338 for deciding whether the control action helps to optimize the objective function, a provision block 1346 for providing one or more quality control (QC) criteria, a decision block 1350 following a “Yes” branch for deciding whether the control action meets the one or more quality control criteria, and an issuance block 1358 following a “Yes” branch for issuing the control action where the decision blocks 1338 and 1350 decide that the control action helps to optimize the objection function and that the one or more QC criteria are met.

In the example of FIG. 13, the decision block 1332, in a “No” branch, can continue to a retrain block 1326 where the model is retrained (e.g., additionally trained, etc.) using information for a number of performed stages (e.g., last M stages). In the example of FIG. 13, the decision blocks 1338 and 1350 can, in respective “No” branches, continue to dismissal blocks 1342 and 1354, which can provide for dismissing the control action, for example, as not helping to optimize the objective function per the decision block 1338 and as not meeting one or more of the one or more QC criteria per the decision block 1350.

The method 1300 may be implemented in whole or in part by a system as a single method or as multiple instances, for example, consider multiple instances that utilize different trained machine learning models for the same control action. In such an example, an ensemble approach may be taken where one or more models of the ensemble may provide for the most accurate prediction (see, e.g., the decision block 1322) and/or for the most reasonable result of testing the control action (see, e.g., the test block 1330). As an example, multiple instances may be executed synchronously and/or asynchronously to handle multiple control actions, where each of the multiple control actions may be assessed using a single model or may be assessed using an ensemble of models.

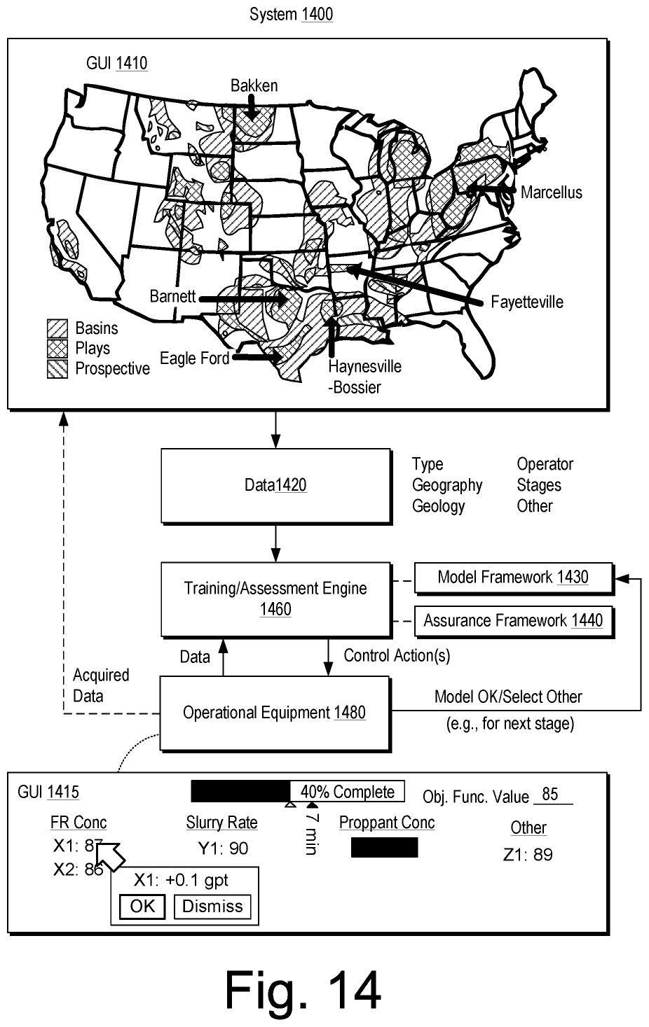

FIG. 14 shows an example of a system 1400 that can generate information for rendering one or more graphical user interfaces (GUIs) 1410 and 1415 that can include one or more interactive GUIs, a data block 1420 for acquiring data (e.g., a network interface that can operatively couple to a network), a computerized model framework 1430, a computerized assurance framework 1440, a computerized training and assessment engine 1460 and operational equipment 1480, which can be utilized to control and/or perform one or more field operations such as one or more hydraulic fracturing operations.

As shown, the GUI 1410 can be associated with data from one or more geographic regions where reservoirs and wells exist. One or more portions of such data may be selected and received by the data block 1420. As an example, data may include data based on type of operation, type of geography, type of geology, type of operator (e.g., or specific operator), number of stages, and/or one or more other types of data. As mentioned, data can include offset well data, data from a well that is drilled from the same pad as a well where the operational equipment 1480 is to perform one or more operations, etc. For example, a pad can be a structure built in the field from which a number of wells are drilled. Such wells may be drilled into an unconventional reservoir such as, for example, a shale reservoir where the wells can be utilized for performing hydraulic fracturing operations to enhance drainage of fluid from the unconventional reservoir. In such an example, stages may aim to limit fracture extent to a particular well such that a fracture is not in direct fluid communication with multiple wells. For example, a drainage area may be defined and exist for each well where, for multiple wells, drainage areas can be tailored in an effort to optimize production from a reservoir. As an example, fracturing can be well-by-well where a number of stages are executed for one well before proceeding to a subsequent well. As explained, data and/or results from one well may be utilized to enhance operations for another well.

In the example of FIG. 14, an arrow from the operational equipment 1480 to the model framework 1430 can provide for model selection, which may be for the same well (e.g., a subsequent stage) and/or for another well. In the example of FIG. 14, a dashed arrow indicates that acquired data from the operational equipment 1480 may be directed to a database or databases as may be accessible via the GUI 1410.

As to the assurance framework 1440, it may be operatively coupled to one or more databases that aim to provide criteria such as safety criteria, quality assurance criteria, etc. As an example, a criterion may be dynamic. For example, consider use of microseismic monitoring equipment to determine an extent of hydraulic fracturing where the extent may be utilized to define a criterion for subsequent hydraulic fracturing. Such a criterion may, for example, aim to reduce risk of a hydraulic fracture being in direct communication with another well (e.g., via a wellbore, a hydraulic fracture of the other well, etc.). As an example, the operational equipment 1480 and/or data acquired thereby may be accessible by the assurance framework 1440, which can be utilized to generate one or more criteria for assessing one or more control actions.

As explained, a control action can be a possible control action that can be assessed as to its potential benefit and as to its ability to meet one or more assurance criteria. As explained, benefit can be determined using one or more objective functions that can output quantitative information, which may be utilized to rank one control action against another. In such an example, multiple control actions may be ranked and/or multiple control actions of a particular type may be ranked. For example, the GUI 1415 shows a graphic that represents status of an operation performed by the operational equipment 1480 where the operation is 40% complete at a current time and where an objective function value is 85, which may be a single or a composite objective function value. The GUI 1415 also shows types of control actions, including FR concentration control actions, slurry rate control actions, proppant concentration control actions and other control actions. At the given current time, the training/assessment engine 1460 has output two FR concentration control actions labeled X1 and X2 where each has an associated metric, which can be an objective function value or other quantitative measure of benefit. In such example of FIG. 14, the metric may be comparable to the objective function value rendered near the top of the GUI 1415, which is given as 85. Such information may assist an operator and/or a controller in decision making as to which control action or control actions to implement. In the example of FIG. 14, the GUI 1415 shows a cursor arrow that may be utilized to hover over and/or select a control action. As shown, a graphical control may be rendered in response that renders additional detail as to a control action along with one or more graphical control buttons that are selectable. For example, where an operation has a human in the loop (HITL), such an approach may be a semi-automated approach where a human operator decides whether or not to implement a control action. As explained, in an automated approach, logic may be utilized to select one or more recommended control actions for implementation. For example, consider logic that selects a control action at a given time interval where the control action is selected based on its metric as being indicative of benefit. As explained, the GUI 1415 can be a real-time GUI that is updated in a relatively continuous manner. As such, control actions may appear and then disappear as the status moves toward 100 percent completion. Further, after selection and implementation of a control action, the dynamics of an operation may change such that one or more of the other control actions may no longer be viable. As explained, in some instances two or more control actions may be compatible, or not.

In the example of FIG. 14, the system 1400 can provide logic that allows for proper management of control actions dynamically, in real-time, where waiting time or delay may be built into a particular control action, which, as mentioned, may be for the same and/or one or more other types of control action. For example, FR concentration may be adjustable at a valve and/or a pump at a frequency of once every 2 minutes, where a latency can exist between a change at surface and delivery of the change downhole, which can be due to flow rate (e.g., slurry rate, etc.), length of well, etc. As such, the system 1400 may account for the frequency and/or latency and implement a blackout period where the blackout period may involve rendering of control actions to a GUI such as the GUI 1415 or not, where, if rendered, a graphical control such as a button may be greyed out as being inactive due to the blackout period. As explained, control actions may be independent or may be interdependent. Logic of the system 1400 can be utilized to manage control actions such that even if a control action passes assurances (e.g., a QA check), it may have other restrictions due to equipment specifications, operational dynamics, etc. The ability of a GUI to render information can assist with operator knowledge as the operator may be better able to judge performance of one or more trained models, etc., while the GUI may still provide restrictions such that timings, equipment capabilities, etc., are taken into account.

As to a blackout period for one or more control actions. As an example, the status graphic may include an indicator that lets a user know when the blackout period will end. For example, consider a line or color bar that is rendered at a future time. As an example, upon selection of a control action for consideration, the GUI 1415 may automatically render information as to a blackout period if one is associated with that control action. As an example, the GUI 1415 may, upon a hover over a particular control action (e.g., or other selection for consideration), highlight or blackout one or more other control actions to demonstrate that they are not to be implemented as they may be incompatible or otherwise not available if the particular control action is implemented. As shown in the GUI 1415, a blackout box appears in the proppant concentration column responsive to selection of the control action X1 for consideration and an indicator is rendered with the status graphic to indicate that a 7-minute blackout period will occur if the control action X1 is implemented (e.g., at the current time or a short time thereafter). Thus, where a HITL approach is taken, a human operator may be informed dynamically as to various aspects of one or more control actions. Further, a human operator may know that she cannot wait too long or the control action may no longer be viable. While the example GUI 1415 shows a blackout period indicator, as an example, it may show a viable time period indicator additionally or alternatively. For example, consider another indicator with 2 minutes, which indicates that the control action X1 is viable for the next 2 minutes, which may be a countdown timer such that the time indicated changes and counts down to zero, at which time, the control action X1 will disappear as being automatically dismissed.

In the example of FIG. 14, if prediction accuracy of one or more trained machine learning models is below a desired level, as explained, one or more remedial actions may be taken, which can, for example, be via the model framework 1430, optionally including training using additional data, which can be from one or more operations that have been performed or that are being performed. As explained, one type of prediction can be treatment pressure. If a moving average of the predicted treatment pressure and the actual treatment pressure deviates beyond a threshold, an automatic process may be implemented that aims to improve prediction accuracy (e.g., by additional training, selection of another model, etc.).

As to various types of control actions, consider, as examples, one or more of the following: concentration of friction reducer, concentration of viscosifier, concentration of scale reducer, adjustment of a proppant ramp schedule, and adjustment of a slurry pumping rate.

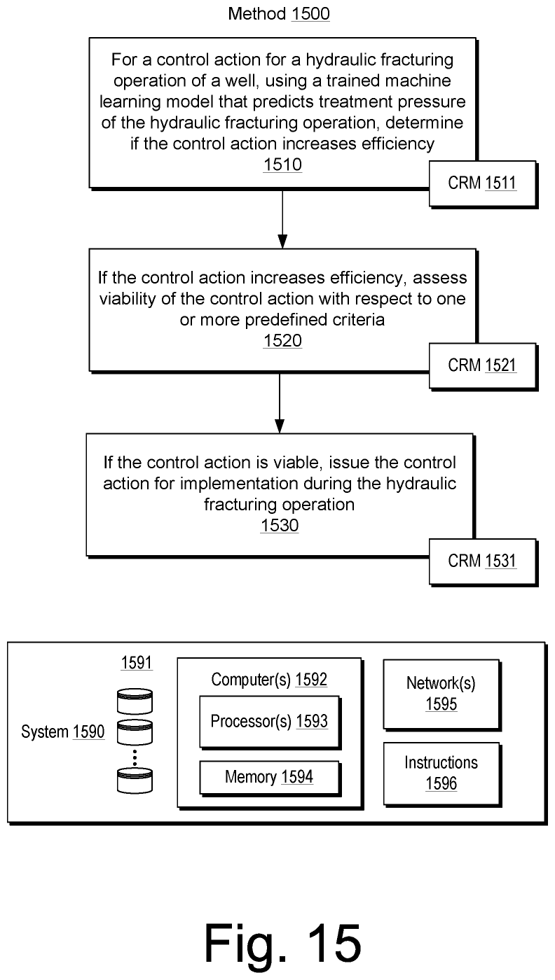

FIG. 15 shows an example of a method 1500 that includes a determination block 1510 that, for a control action for a hydraulic fracturing operation of a well, using a trained machine learning model that predicts treatment pressure of the hydraulic fracturing operation, determines if the control action increases efficiency (see also, e.g., the block 1338 of FIG. 13); an assessment block 1520 that, if the control action increases efficiency, assesses viability of the control action with respect to one or more predefined criteria (see also, e.g., the block 1350 of FIG. 13); and an issuance block 1530 that, if the control action is viable, issues the control action for implementation during the hydraulic fracturing operation. For example, the method 1500 can include, for a control action for a hydraulic fracturing operation of a well, using a trained machine learning model that predicts treatment pressure of the hydraulic fracturing operation, per the determination block 1510, determining if the control action increases efficiency; if the control action increases efficiency, per the assessment block 1520, assessing viability of the control action with respect to one or more predefined criteria; and, if the control action is viable, per the issuance block 1530, issuing the control action for implementation during the hydraulic fracturing operation.

As an example, a method can include, for a control action for a hydraulic fracturing operation of a well, using a trained machine learning model that predicts treatment pressure of the hydraulic fracturing operation, determining if the control action increases efficiency; responsive to the control action increasing efficiency, assessing viability of the control action with respect to one or more predefined criteria; and responsive to the control action being viable, issuing the control action for implementation during the hydraulic fracturing operation.

As an example, a system can include executable instructions to: for a control action for a hydraulic fracturing operation of a well, using a trained machine learning model that predicts treatment pressure of the hydraulic fracturing operation, determine if the control action increases efficiency; responsive to the control actions increasing efficiency, assess viability of the control action with respect to one or more predefined criteria; and responsive to the control action being viable, issue the control action for implementation during the hydraulic fracturing operation.

In the example of FIG. 15, a system 1590 includes one or more information storage devices 1591, one or more computers 1592, one or more networks 1595 and instructions 1596. As to the one or more computers 1592, each computer may include one or more processors (e.g., or processing cores) 1593 and memory 1594 for storing the instructions 1596, for example, executable by at least one of the one or more processors. As an example, a computer may include one or more network interfaces (e.g., wired or wireless), one or more graphics cards, a display interface (e.g., wired or wireless), etc.

The method 1500 is shown along with various computer-readable media blocks 1511, 1521, and 1531 (e.g., CRM blocks). Such blocks may be utilized to perform one or more actions of the method 1500. For example, consider the system 1590 of FIG. 15 and the instructions 1596, which may include instructions of one or more of the CRM blocks 1511, 1521 and 1531.

As mentioned, a method can include, for a control action for a hydraulic fracturing operation of a well, using a trained machine learning model that predicts treatment pressure of the hydraulic fracturing operation, determining if the control action increases efficiency; if the control action increases efficiency, assessing viability of the control action with respect to one or more predefined criteria; and, if the control action is viable, issuing the control action for implementation during the hydraulic fracturing operation. In such an example, the efficiency may be measured using one or more objective functions where, for example, the efficiency may be a metric (e.g., an objective function value, a metric derived from objective function values, etc.).

As an example, issuing can include rendering a graphical user interface to a display where the graphical user interface includes a visualization of one or more control actions. As an example, a graphical user interface can include a visualization derived from real-time data acquired during performance of a hydraulic fracturing operation.

As an example, a method can include implementing an issued control action to adjust a hydraulic fracturing operation.

As an example, a method can include determining prediction accuracy of a trained machine learning model using treatment pressure data acquired for a prior hydraulic fracturing operation of a well. In such an example, the hydraulic fracturing operation may be a stage of a multi-stage process and the prior hydraulic fracturing operation may be a prior stage of the multi-stage process. As an example, a method can include training a machine learning model using data acquired during a prior stage of a multi-stage process. In such an example, the method can include weighting the data acquired during the prior stage (e.g., consider weighting data in accordance with stage number to weight older stages with lesser weights).

As an example, a trained machine learning model can include a regression model that predicts treatment pressure based on model inputs. As an example, a model can be a random forest model, a recurrent neural network model, or another type of regression model.

As an example, a trained machine learning model can include a convolution neural network (CNN) model that predicts treatment pressure with respect to time. For example, consider using a CNN model to predict future behavior such as future treatment pressures.

As an example, a method can include using an ensemble of trained machine learning models that predict treatment pressures. In such an example, the ensemble can include at least one regression model and at least one convolution neural network model.

As an example, a control action may be a hypothetical control action where an increase in efficiency is a proof of the hypothetical control action being suitable for further consideration.

As an example, a control action can be for control of concentration of at least one material of a hydraulic fracturing operation.

As an example, a control action can be for adjustment of at least one schedule of actions with respect to time.

As an example, a method can include considering a plurality of control actions, where the plurality of control actions can be one or more types of control actions.

As an example, a system can include a processor; memory accessible to the processor; processor-executable instructions stored in the memory and executable to instruct the system to: for a control action for a hydraulic fracturing operation of a well, using a trained machine learning model that predicts treatment pressure of the hydraulic fracturing operation, determine if the control action increases efficiency; if the control action increases efficiency, assess viability of the control action with respect to one or more predefined criteria; and, if the control action is viable, issue the control action for implementation during the hydraulic fracturing operation.

As an example, a computer-program product and/or one or more computer-readable storage media can include computer-executable instructions executable to instruct a computing system to: for a control action for a hydraulic fracturing operation of a well, using a trained machine learning model that predicts treatment pressure of the hydraulic fracturing operation, determine if the control action increases efficiency; if the control action increases efficiency, assess viability of the control action with respect to one or more predefined criteria; and, if the control action is viable, issue the control action for implementation during the hydraulic fracturing operation.

As an example, a computer program product can include instructions to instruct a computing system to perform one or more methods as described herein.

As an example, a system may include instructions, which may be provided to analyze data, control a process, perform a task, perform a workstep, perform a workflow, etc.

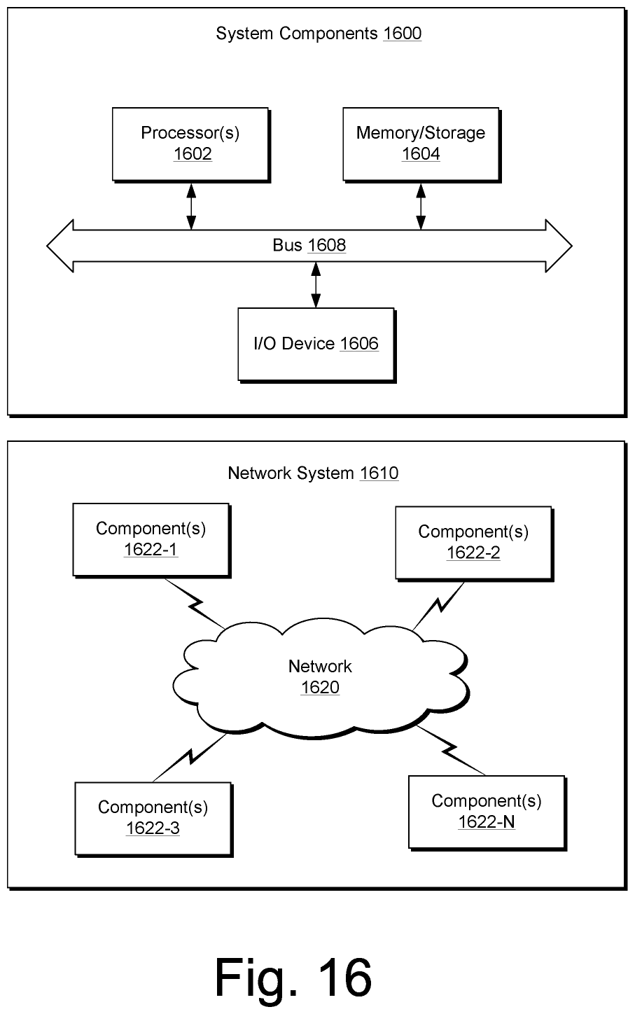

FIG. 16 shows components of an example of a computing system 1600 and an example of a networked system 1610 and a network 1620. The system 1600 includes one or more processors 1602, memory and/or storage components 1604, one or more input and/or output devices 1606 and a bus 1608. In an example embodiment, instructions may be stored in one or more computer-readable media (e.g., memory/storage components 1604). Such instructions may be read by one or more processors (e.g., the processor(s) 1602) via a communication bus (e.g., the bus 1608), which may be wired or wireless. The one or more processors may execute such instructions to implement (wholly or in part) one or more attributes (e.g., as part of a method). A user may view output from and interact with a process via an I/O device (e.g., the device 1606). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1610, which includes a network 1620. The network system 1610 includes components 1622-1, 1622-2, 1622-3, . . . 1622-N. For example, the components 1622-1 may include the processor(s) 1602 while the component(s) 1622-3 may include memory accessible by the processor(s) 1602. Further, the component(s) 1622-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
for a control action for a hydraulic fracturing operation of a well, using a trained machine learning model that predicts treatment pressure of the hydraulic fracturing operation, determining if the control action increases efficiency;
if the control action increases efficiency, assessing viability of the control action with respect to one or more predefined criteria; and
if the control action is viable, issuing the control action for implementation during the hydraulic fracturing operation.

2. The method of claim 1, wherein the issuing comprises rendering a graphical user interface to a display wherein the graphical user interface comprises a visualization of the control action.

3. The method of claim 2, wherein the graphical user interface comprises a visualization derived from real-time data acquired during performance of the hydraulic fracturing operation.

4. The method of claim 1, comprising implementing the control action to adjust the hydraulic fracturing operation.

5. The method of claim 1, comprising determining prediction accuracy of the trained machine learning model using treatment pressure data acquired for a prior hydraulic fracturing operation of the well.

6. The method of claim 5, wherein the hydraulic fracturing operation is a stage of a multi-stage process and wherein the prior hydraulic fracturing operation is a prior stage of the multi-stage process.

7. The method of claim 6, comprising training the machine learning model using data acquired during the prior stage of the multi-stage process.

8. The method of claim 7, comprising weighting the data acquired during the prior stage.

9. The method of claim 1, wherein the trained machine learning model comprises a regression model that predicts the treatment pressure based on model inputs.

10. The method of claim 1, wherein the regression model comprises a random forest model.

11. The method of claim 1, wherein the regression model comprises a recurrent neural network model.

12. The method of claim 1, wherein the trained machine learning model comprises a convolution neural network model that predicts treatment pressure with respect to time.

13. The method of claim 1, comprising using an ensemble of trained machine learning models that predict treatment pressures.

14. The method of claim 13, wherein the ensemble comprises at least one regression model and at least one convolution neural network model.

15. The method of claim 1, wherein the control action is a hypothetical control action and an increase in efficiency is a proof of the hypothetical control action.

16. The method of claim 1, wherein the control action controls concentration of at least one material of the hydraulic fracturing operation.

17. The method of claim 1, wherein the control action adjusts at least one schedule of actions with respect to time.

18. The method of claim 1, comprising considering a plurality of control actions, wherein the plurality of control actions comprise one or more types of control actions.

19. A system comprising:
a processor;
memory accessible to the processor;
processor-executable instructions stored in the memory and executable to instruct the system to:
for a control action for a hydraulic fracturing operation of a well, using a trained machine learning model that predicts treatment pressure of the hydraulic fracturing operation, determine if the control action increases efficiency;
if the control action increases efficiency, assess viability of the control action with respect to one or more predefined criteria; and
if the control action is viable, issue the control action for implementation during the hydraulic fracturing operation.

20. One or more computer-readable storage media comprising computer-executable instructions executable to instruct a computing system to:
for a control action for a hydraulic fracturing operation of a well, using a trained machine learning model that predicts treatment pressure of the hydraulic fracturing operation, determine if the control action increases efficiency;
if the control action increases efficiency, assess viability of the control action with respect to one or more predefined criteria; and
if the control action is viable, issue the control action for implementation during the hydraulic fracturing operation.
